(19) United States
(12) Patent Application Publication
(10) Pub. No.: US 2024/0076449 A1
(43) Pub. Date: Mar. 7, 2024

(54) BIOBASED COPOLYMERS OF POLY(ETHYLENE TEREPHTHALATE) WITH SUPERIOR THERMOMECHANICAL PROPERTIES

(71) Applicant: Iowa State University Research Foundation, Inc., Ames, IA (US)

(72) Inventors: Eric William Cochran, Ames, IA (US); George A. Kraus, Ames, IA (US); Ting-Han Lee, Ames, IA (US); Michael J. Forrester, Ames, IA (US)

(21) Appl. No.: 18/357,269

(22) Filed: Jul. 24, 2023

Related U.S. Application Data
(60) Provisional application No. 63/393,064, filed on Jul. 28, 2022.

(51) Int. Cl. C08G 65/34; C08L 71/08

(52) U.S. Cl. CPC C08G 65/34; C08L 71/08; C08G 2230/00; C08L 2201/06; C08L 2203/16

(57) ABSTRACT

The present application is directed to a polymer comprising a moiety of formula:

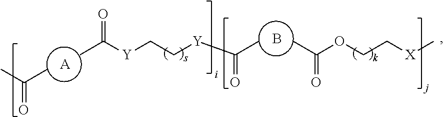

wherein

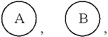

X, Y, i, j, s, and k are as described herein and salts thereof and to a process of preparing such a polymer.

This application claims the benefit of U.S. Provisional Patent Application Ser. No. 63/393,064, filed Jul. 28, 2022, which is hereby incorporated by reference in its entirety.

### FIELD

The present application relates to biobased copolymers of poly(ethylene terephthalate) with superior thermomechanical properties.

### BACKGROUND

Polyethylene terephthalate (PET) is one of the most-consumed thermoplastics as well as single-use plastics (SUPs) in the world for numerous applications, representing approximately 18% of the global plastic market with an annual production of around 50 million metric tons (Eerhart et al., “Replacing Fossil Based PET with Biobased PEF; Process Analysis, Energy and GHG Balance,” Energy & Environmental Science 5:6407-6422 (2012)). It is a part of daily life due to its low cost, durability, and plethora of other desirable properties (Sinha et al., “PET Waste Management by Chemical Recycling: A Review,” Journal of Polymers and the Environment 18:8-25 (2010)). Compared to other plastics, PET has good thermal and mechanical properties, as well as excellent chemical resistance to most solvents. Owing to its performance, it is reported to have been used to make fibers, sheets, and films, and, more specifically, it is used in food and beverage packaging, electronics and communication devices, automotive parts, lighting products, sports goods, textiles, and healthcare applications, etc. (Shojaei et al., “Chemical Recycling of PET: A Stepping-Stone Toward Sustainability,” Polymers for Advanced Technologies 31:2912-2938 (2020); Yue et al., “Glycolysis of Poly (Ethylene Terephthalate)(PET) Using Basic Ionic Liquids as Catalysts,” Polymer Degradation and Stability 96:399-403 (2011)). Nonetheless, there are some shortcomings: for example, PET cannot withstand hot water cleaning and pasteurization due to its low glass transition temperature (T_{g}), which increases the risk for bacteria and microorganisms growth during reuse. Moreover, while the barrier performance of PET is acceptable for H₂O and CO₂, it has poor O₂ barrier making it poorly suited to many oxygen-sensitive products such as most liquors (Polyakova et al., “Oxygen-Barrier Properties of Copolymers Based on Ethylene Terephthalate,” Journal of Polymer Science Part B: Polymer Physics 39:1889-1899 (2001); Cava et al., “Comparative Performance and Barrier Properties of Biodegradable Thermoplastics and Nanobiocomposites Versus PET for Food Packaging Applications,” Journal of Plastic Film & Sheeting 22:265-274 (2006)).

These limitations have motivated the development of multiple pathways to improve PET performance to meet the requirements for more stringent applications. For instance, the introduction of fillers/fibers can improve the mechanical properties, although not without tradeoffs (Shen et al., “Polystyrene-Block-Polydimethylsiloxane as a Potential Silica Substitute for Polysiloxane Reinforcement,” ACS Macro Letters 9:781-787 (2020); Shen et al., “Easy-Processable and Aging-Free All-Polymer Polysiloxane Composites,” ACS Applied Polymer Materials 2:5835-5844 (2020)). For example, often the fillers require compatibilizers to improve interfacial adhesion, adding significant complexity and cost (López de Dicastillo et al., “The Use of Nanoadditives Within Recycled Polymers for Food Packaging: Properties, Recyclability, and Safety,” Comprehensive Reviews in Food Science and Food Safety 19:1760-1776 (2020); Rezaeian et al., “An Investigation on the Rheology, Morphology, Thermal and Mechanical Properties of Recycled Poly (Ethylene Terephthalate) Reinforced with Modified Short Glass Fibers,” Polymer Composites 30:993-999 (2009); Khan et al., “Tensile and Flexural Properties of Natural Fiber Reinforced Polymer Composites: A Review,” Journal of Reinforced Plastics and Composites 37:1435-1455 (2018)). Moreover, fillers/fibers are problematic at the end-of-life by acting as contaminants in recycling stream.

Alternatively, the PET resin itself can be improved through the partial or complete substitution of the terephthalate unit with analogous rigid segments. Comonomers like isophthalic acid (IPA), 1,4-cyclohexanedimethanol (CHDM), and diethylene glycol (DEG) are used frequently to optimize the properties for particular applications by depressing the melt temperature (e.g., for ease-of-processing) or by altering the crystallinity (e.g., for optical clarity) (Hergenrother, W. “Influence of Copolymeric Poly (Diethylene Glycol) Terephthalate on the Thermal Stability of Poly (Ethylene Terephthalate),” Journal of Polymer Science: Polymer Chemistry Edition 12:875-883 (1974); Karayannidis et al., “Thermal Behavior and Tensile Properties of Poly (Ethylene Terephthalate-co-Ethylene Isophthalate),” Journal of Applied Polymer Science 78:200-207 (2000); Chen et al., “Alkali Resistance of Poly (Ethylene Terephthalate)(PET) and Poly (Ethylene Glycol-co-1,4-Cyclohexanedimethanol Terephthalate)(PETG) Copolyesters: The Role of Composition,” Polymer Degradation and Stability 120:232-243 (2015)). However, these other rigid segments can result in a deterioration in other properties such as thermal and barrier aspects, and their petrochemical nature raises environmental concerns such as greenhouse gas emissions and a lack of sustainability.

Amongst the highest-performance known terephthalate alternatives is 2,6-naphthalene dicarboxylate (2,6-N), which has received both academic and industrial attention in PET copolymers as well as in poly(ethylene 2,6-naphthalate) (26PEN) homopolymer (Ihm et al., “Miscibility of Poly (Ethylene Terephthalate)/Poly (Ethylene 2,6-Naphthalate) Blends by Transesterification,” Journal of Polymer Science Part A: Polymer Chemistry 34:2841-2850 (1996); Lee et al., “Phase Behaviour and Transesterification in Poly (Ethylene 2,6-Naphthalate) and Poly (Ethylene Terephthalate) Blends,” Polymer 38:4831-4835 (1997); Aoki et al., “Dynamic Mechanical Properties of Poly (Ethylene Terephthalate)/Poly (Ethylene 2,6-Naphthalate) Blends,” Macromolecules 32:1923-1929 (1999); Chen et al., “Crystal Structure and TensileFracture Morphology of Poly (Ethylene Terephthalate)-co-Poly (Ethylene 2,6-Naphthalate) Block Copolyesters and Fibers,” Industrial & Engineering Chemistry Research 59:18717-18725 (2020)). The rigidity and stability of the 2,6-N fused aromatic yields polymers superior to PET in most respects including thermal, mechanical, and barrier properties. The high service temperature and barrier performance are attractive for hot-filling and liquor packaging applications; however, cost, limited availability, and environmental considerations narrow the use of 2,6-N even for PET copolymers in partial substitution of terephthalate to very high-value, low-volume applications such as high-end packaging, films, and fibers.

Amid dramatic price volatility in crude oil and concerns over the sustainability of chemical manufacturing, moreover, there is an earnest search for renewable building blocks that can compete with petroleum-based comonomers (such as 2,6-N) (Zhang, Y., “The Links Between the Price of Oil and the Value of US Dollar,” International Journal of Energy Economics and Policy 3:341-351 (2013); Lipinsky, E., “Chemicals from Biomass: Petrochemical Substitution Options,” Science 212:1465-1471 (1981); Liu et al., “Paired and Tandem Electrochemical Conversion of 5-(Hydroxymethyl) Furfural Using Membrane-Electrode Assembly-Based Electrolytic Systems,” ChemElectroChem 8:2817-2824 (2021); Liu et al., “Paired Electrolysis of 5-(Hydroxymethyl) Furfural in Flow Cells with a High-Performance Oxide-Derived Silver Cathode,” Green Chemistry 23:5056-5063 (2021); Goyal et al., “Glycerol Ketals as Building Blocks for a New Class of Biobased (Meth) Acrylate Polymers,” ACS Sustainable Chemistry & Engineering 9:10620-10629 (2021); Forrester et al., “RAFT Thermoplastics from Glycerol: A Biopolymer for Development of Sustainable Wood Adhesives,” Green Chemistry 22:6148-6156 (2020); Lin et al., “Self-Assembly of Poly (Styrene-Block-Acrylated Epoxidized Soybean Oil) Star-Brush-Like Block Copolymers,” Macromolecules 53:8095-8107 (2020); Lin et al., “Gelation Suppression in RAFT Polymerization,” Macromolecules 52:7005-7015 (2019); Carraher et al., “Solvent-Driven Isomerization of Cis, Cis-Muconic Acid for the Production of Specialty and Performance-Advantaged Cyclic Biobased Monomers,” Green Chemistry 22:6444-6454 (2020)).

Inspired by these concerns and the potential utility of the naphthalate homo- and copolyesters, a family of biomass-derived poly(ethylene naphthalate) homopolymers as sustainable and potentially lower-cost 26PEN alternatives was recently reported (Lee et al., “Next-Generation High-Performance Bio-Based Naphthalate Polymers Derived from Malic Acid for Sustainable Food Packaging,” ACS Sustainable Chemistry & Engineering 10:2624-2633 (2022)).

Amongst these, 2,7-naphthalene dicarboxylate (2,7-N) was found to be especially promising. Derived from malic acid, 2,7-N is structurally analogous to 2,6-N in the same manner as meta-substituted isophthalate to para-substituted terephthalate. Like 26PEN, poly(ethylene 2,7-naphthalate) (2,7-PEN) was found to exhibit exceptional thermal and barrier performance; however, these homopolymers were brittle due to their sluggish crystallization kinetics. Thus, while 2,7-PEN has many appealing properties, its prospects for use in applications where resilience to even modest mechanical distress is needed appear to be limited without remediation.

The production of 2,6-N originates with the combination of m-xylene and butadiene, and goes through a multistep process including alkylation, cyclization, (de)hydrogenation, oxidation, etc. (Scheirs et al., “Modern Polyesters: Chemistry and Technology of Polyesters and Copolyesters,” John Wiley & Sons (2005)). Butadiene comes from naphtha feedstock, which has become increasingly scarce as the refining complex has shifted to natural gas processing. It is only manufactured at select locations globally and is subject to massive price fluctuations due to crude oil. Moreover, its life cycle impacts include CO₂ emissions of 2.518 kg per kg and energy consumption of 65 MJ per kg (Cabrera Camacho et al., “Techno-Economic and Life-Cycle Assessment of One-Step Production of 1,3-Butadiene from Bioethanol Using Reaction Data Under Industrial Operating Conditions,” ACS Sustainable Chemistry & Engineering 8:10201-10211 (2020)). Conversely, bio-derived 2,7-N is produced primarily from malic acid, which is obtained readily from many fruit extracts, while industrial methods have focused on metabolically engineering microbial strains to generate sufficient volumes (Lee et al., “Upgrading Malic Acid To Bio-Based Benzoates Via a Diels-Alder-Initiated Sequence with the Methyl Coumalate Platform,” RSC Advances 4:45657-45664 (2014)). In addition, malic acid is already commercially available as a food additive for <$1 per kg in the market, which has both economically and environmentally more competitive advantages than the raw material of 2,6-N.

The present application is directed to overcoming these and other deficiencies in the art.

### SUMMARY

One aspect of the present application relates to a polymer comprising a moiety of formula:

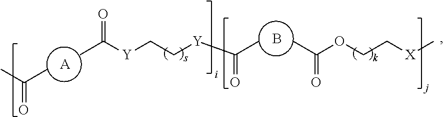

wherein

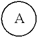

is monocyclic or bicyclic arylene, monocyclic or bicyclic heteroarylene, or monocyclic or bicyclic non-aromatic heterocyclene;

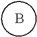

is monocyclic or bicyclic arylene, monocyclic or bicyclic heteroarylene, or monocyclic or bicyclic non-aromatic heterocyclene, wherein monocyclic or bicyclic arylene, monocyclic or bicyclic heteroarylene, or monocyclic or bicyclic non-aromatic heterocyclene can be optionally substituted from 1 to 3 times with R;
X is NH or O;
Y is NH or O;
R is independently selected at each occurrence thereof from the group consisting of H, OH, and —OR′;
R′ is C₁₋₂₀ alkyl, C₂₋₂₀ alkenyl, or C₂₋₂₀ alkynyl;
s is 1 to 21;
k is 1 to 21;
i and j represent number average degrees of polymerization for repeat units of formula I that are distributed throughout the polymer chain in a statistically defined manner;
i is 1 to 1,000,000; and
j is 1 to 1,000,000;
or a salt thereof.

Another aspect of the present application relates to a process for preparation of a polymer comprising a moiety of formula:

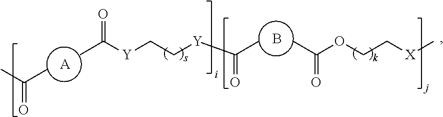

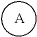

is monocyclic or bicyclic arylene, monocyclic or bicyclic heteroarylene, or monocyclic or bicyclic non-aromatic heterocyclene;

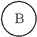

is monocyclic or bicyclic arylene, monocyclic or bicyclic heteroarylene, or monocyclic or bicyclic non-aromatic heterocyclene, wherein monocyclic or bicyclic arylene, monocyclic or bicyclic heteroarylene, or monocyclic or bicyclic non-aromatic heterocyclene can be optionally substituted from 1 to 3 times with R;
X is NH or O;
Y is NH or O;
R is independently selected at each occurrence thereof from the group consisting of H, OH, and —OR′;
R′ is C₁₋₂₀ alkyl, C₂₋₂₀ alkenyl, or C₂₋₂₀ alkynyl;
s is 1 to 21;
k is 1 to 21;
i and j represent number average degrees of polymerization for repeat units of formula I that are distributed throughout the polymer chain in a statistically defined manner;
i is 1 to 1,000,000; and
j is 1 to 1,000,000;
or a salt thereof.

This process comprises:
providing a compound having the structure of formula (IV):

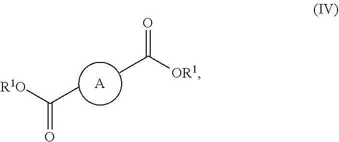

wherein R¹ is H or C₁₋₆ alkyl;
providing a compound having the structure of formula (V):

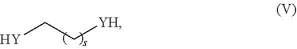

or a salt thereof,
providing a compound having the structure of formula (VI):

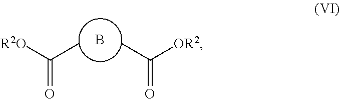

wherein R² is H or C₁₋₆ alkyl;
providing a compound having the structure of formula (VII):

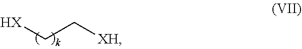

or a salt thereof, and
reacting the compound of formula (IV), the compound of formula (V), the compound of formula (VI), and the compound of formula (VII) under conditions effective to produce the polymer.

Another aspect of the present application relates to a process for preparation of a polymer comprising a moiety of formula:

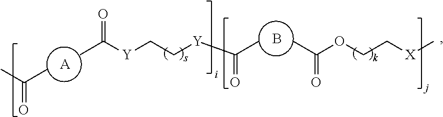

wherein

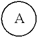

is monocyclic or bicyclic arylene, monocyclic or bicyclic heteroarylene, or monocyclic or bicyclic non-aromatic heterocyclene;

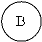

is monocyclic or bicyclic arylene, monocyclic or bicyclic heteroarylene, or monocyclic or bicyclic non-aromatic heterocyclene, wherein monocyclic or bicyclic arylene, monocyclic or bicyclic heteroarylene, or monocyclic or bicyclic non-aromatic heterocyclene can be optionally substituted from 1 to 3 times with R;
X is NH or O;
Y is NH or O;
R is independently selected at each occurrence thereof from the group consisting of H, OH, and —OR′;
R′ is C₁₋₂₀ alkyl, C₂₋₂₀ alkenyl, or C₂₋₂₀ alkynyl;
s is 1 to 21;
k is 1 to 21;
i and j represent number average degrees of polymerization for repeat units of formula I that are distributed throughout the polymer chain in a statistically defined manner;
i is 1 to 1,000,000; and
j is 1 to 1,000,000;
or a salt thereof.

This process comprises:
providing a compound having the structure of formula (II):

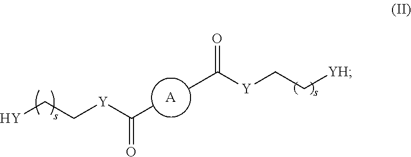

providing a compound having the structure of formula (III):

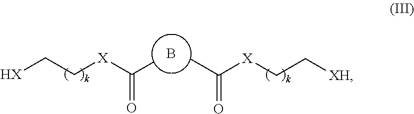

or a salt thereof, and
reacting the compound of formula (II) with the compound of formula (III) under conditions effective to produce the polymer.

According to a study examining the structure-property relationships in a series of nylon-6,6 copolymers, the future of sustainable materials may be more accessible through a more gradual bootstrapping process (Abdolmohammadi et al., “Analysis of the Amorphous and Interphase Influence of Comononomer Loading on Polymer Properties Toward Forwarding Bioadvantaged Copolyamides,” Macromolecules 54:7910-7924 (2021), which is hereby incorporated by reference in its entirety). It was hypothesized that novel “bioadvantaged” chemicals may find better value as additives that differentiate the properties of legacy materials whose support infrastructure is already in place. With respect to semicrystalline polymers like nylon-6,6, it was found that up to 20 mol % of adipic acid could be replaced without severe disruptions in the nylon crystallinity that serves as the foundation for properties in that materials system. The biobased counit (trans-3-hexene dioate) was effectively partitioned to the amorphous phase, whose properties could therefore be tailored somewhat independently of the crystal phase.

It was assumed that the biobased counit would not significantly affect the crystallization behaviors to a certain extent and allow for the performance to be tailored and might be well-applied to realizing the potential of 2,7-N. While the sluggish 2,7-PEN crystallization rate leads to fragile materials, its superior thermal and barrier properties could be exploited through amorphous-phase modification in PET copolymers. Success in this regard could offer a pathway for commercial adoption of 2,7-N, its role as a valorizing PET additive mitigating the costly barrier-to-entry associated with the immature biochemical industry. The present application describes structure-function relationships between comonomer loading and copolymer properties in a series of poly(ethylene terephthalate-stat-2,7-naphthalate) copolymers. These copolymers were produced using a classic two-step melt polycondensation reaction (FIG. 1) with molecular weights similar to those of industrial-grade resins. The 2,7-N substitution rates near 20 mol % were found to impart optimal improvements in thermal, mechanical, and barrier properties. These copolymers could be scalable alternatives to 26PEN/PET copolymers, providing a pathway to biochemical adoption through enabling high-value materials for demanding applications while managing product expense.

The present application describes a series of novel poly(ethylene terephthalate) (PET) copolymers with improved properties through the incorporation of bioadvantaged dimethyl 2,7-naphthalene di-carboxylate (2,7-N) as a comonomer. A series of poly(ethylene terephthalate-stat-2,7-naphthalate) copolymers were synthesized from ethylene glycol (EG), terephthalic acid (TPA), and 2,7-N via a standard two-step melt polycondensation reaction. The 2,7-N significantly improved the thermal, mechanical, and barrier properties. The glass transition temperature (Tg>75.4° C.) and thermal stability (Td, 5%>405.1° C.) of the copolymers increased monotonically with 2,7-N content, exceeding those of PET (T_{g}=69.7° C., T_{d,5}%=401.4° C.). Moreover, the mechanical properties and the crystallization behaviors were tunable through the 2,7-N loading. Composition-optimized copolymers showed an increase of 70% and 200% in elongation at break and tensile strength, respectively. In addition, the oxygen permeability value of the copolymers containing 20% 2,7-N loading fell to P_{O2}=0.0073 barrer, a 30% improvement over that of PET.

### BRIEF DESCRIPTION OF THE DRAWINGS

FIG. 1 shows step-growth polycondensation of naphthalate-based copolymers via a two-step polymerization.

FIG. 2 shows step-growth polycondensation of isophthalate-based copolymers via a two-step polymerization.

FIG. 3 shows ¹H NMR spectra of the dyad fractions of NN, NT/TN, and TT of PET and naphthalate-based copolymers.

FIG. 4 shows ¹H NMR spectra of polyethylene terephthalate (PET) and naphthalate-based copolymers.

FIG. 5 shows ¹H NMR spectra of PET and isophthalate-based copolymers.

FIGS. 6A-B show gel permeation chromatography (GPC) analysis of naphthalate- and isophthalate-based copolymers: PET, 2,7-PEN5, 2,7-PEN10, 2,7-PEN20, and 2,7-PEN100 (FIG. 6A); and PET, PEI10, PEI20, and PEI100 (FIG. 6B).

FIGS. 7A-B show ATR-FTIR spectra of PET and naphthalate-based copolymers (FIG. 7A) and the superimposed magnified spectra with the wavenumber of 1000-1400 cm⁻¹ (FIG. 7B).

FIGS. 8A-B shows thermographic analysis (TGA) thermograms (FIG. 8A) and differential thermogravimetric (DTG) curves (FIG. 8B) of PET and naphthalate-based copolymers with heating rate of 10° C. min-.

FIGS. 9A-B show TGA thermograms (FIG. 9A) and DTG curve (FIG. 9B) of PET and isophthalate-based copolymers with heating rate of 10° C. min-.

FIGS. 10A-C show wide-angle X-ray scattering (WAXS) patterns of PET and naphthalate-based copolymers: tensile bar quenched from 270° C. (FIG. 10A); after annealing at 175° C. for 6 hours (FIG. 10B); and small-angle X-ray scattering (SAXS) spectra of the samples after annealing at 175° C. for 6 hours (FIG. 10C).

FIGS. 11A-B show WAXS patterns of PET and isophthalate-based copolymers: tensile bar quenched from 270° C. (FIG. 11A) and after annealing at 175° C. for 6 hours (FIG. 11B).

FIGS. 12A-D show relative crystallinity with time for isothermal crystallization of PET and naphthalate-based copolymers at different temperatures.

FIGS. 13A-D show Avrami plots of ln[−ln(1-Xₜ)] versus ln[t] for isothermal crystallization of PET and naphthalate-based copolymers at different temperatures.

FIG. 14 is a graph showing dependence of 1/t_{1/2} on isothermal crystallization temperature (T_{c}) of PET and naphthalate-based copolymers.

FIGS. 15A-B show differential scanning calorimetry (DSC) thermograms of quenched PET and naphthalate-based copolymers at scan rate of 10° C. min⁻¹: heating (FIG. 15A) and cooling (FIG. 15B).

FIGS. 16A-B show DSC thermograms of quenched PET and isophthalate-based copolymers at scan rate of 10° C. min⁻¹: heating (FIG. 16A) and cooling (FIG. 16B).

FIG. 17 is a graph showing T_{g} values of 2,7-PEN copolymers as a function of 27PEN loading and their fitting with the Gordon-Taylor equation.

FIGS. 18A-B show representative stress-strain curves of naphthalate- and isophthalate-based copolymers with the speed of 10 mm-min⁻¹ at room temperature: PET, 2,7-PEN5, 2,7-PEN10, 2,7-PEN20, 2,7-PEN100, PEI10, PEI20, and PEI100.

FIGS. 19A-E show fractured surfaces of PET and naphthalate-based copolymers: PET (FIG. 19A), 2,7-PEN5 (FIG. 19B), 2,7-PEN10 (FIG. 19C), 2,7-PEN20 (FIG. 19D), and 27PEN100 (FIG. 19E).

FIGS. 20A-C show dynamic mechanical analysis (DMA) spectra of PET and naphthalate-based copolymers storage modulus (FIG. 20A), tan (δ) α-relaxation transition (FIG. 20B), and tan (δ) γ-relaxation transition (FIG. 20C).

FIG. 21 shows DMA spectra of PET and isophthalate-based copolymers: tan (6) 7 relaxation transition.

### DETAILED DESCRIPTION

One aspect of the present application relates to a polymer comprising a moiety of formula:

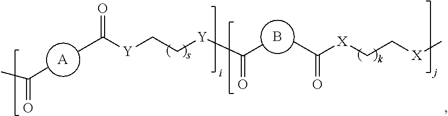

wherein

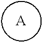

is monocyclic or bicyclic arylene, monocyclic or bicyclic heteroarylene, or monocyclic or bicyclic non-aromatic heterocyclene;

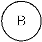

is monocyclic or bicyclic arylene, monocyclic or bicyclic heteroarylene, or monocyclic or bicyclic non-aromatic heterocyclene, wherein monocyclic or bicyclic arylene, monocyclic or bicyclic heteroarylene, or monocyclic or bicyclic non-aromatic heterocyclene can be optionally substituted from 1 to 3 times with R;
X is NH or O;
Y is NH or O;
R is independently selected at each occurrence thereof from the group consisting of H, OH, and —OR′;
R′ is C₁₋₂₀ alkyl, C₂₋₂₀ alkenyl, or C₂₋₂₀ alkynyl;
s is 1 to 21;
k is 1 to 21;
i and j represent number average degrees of polymerization for repeat units of formula I that are distributed throughout the polymer chain in a statistically defined manner;
i is 1 to 1,000,000; and
j is 1 to 1,000,000;
or a salt thereof.

As used above, and throughout the description herein, the following terms, unless otherwise indicated, shall be understood to have the following meanings. If not defined otherwise herein, all technical and scientific terms used herein have the same meaning as is commonly understood by one of ordinary skill in the art to which this technology belongs. In the event that there is a plurality of definitions for a term herein, those in this section prevail unless stated otherwise.

The term “alkyl” means an aliphatic hydrocarbon group which may be straight or branched having about 1 to about 20 carbon atoms in the chain. “Lower alkyl” refers to alkyl groups having about 1 to about 6 carbon atoms in the chain. “Branched” means that one or more lower alkyl groups such as methyl, ethyl, or propyl are attached to a linear alkyl chain. Exemplary alkyl groups include methyl, ethyl, n-propyl, i-propyl, n-butyl, t-butyl, n-pentyl, 3-pentyl, and the like.

The term “alkenyl” means an aliphatic hydrocarbon group containing a carbon carbon double bond and which may be straight or branched having about 2 to about 20 carbon atoms in the chain. Particular alkenyl groups have 2 to about 10 carbon atoms in the chain. “Branched” means that one or more lower alkyl groups such as methyl, ethyl, or propyl are attached to a linear alkenyl chain. Exemplary alkenyl groups include ethenyl, propenyl, n-butenyl, and i-butenyl. The term “alkenyl” may also refer to a hydrocarbon chain having 2 to 20 carbons containing at least one double bond and at least one triple bond.

The term “alkynyl” means an aliphatic hydrocarbon group containing a carbon carbon triple bond and which may be straight or branched having about 2 to about 20 carbon atoms in the chain. Particular alkynyl groups have 2 to about 10 carbon atoms in the chain. “Branched” means that one or more lower alkyl groups such as methyl, ethyl, or propyl are attached to a linear alkynyl chain. Exemplary alkynyl groups include ethynyl, propynyl, n-butynyl, 2-butynyl, 3-methylbutynyl, and n-pentynyl.

The term “aryl” means an aromatic monocyclic or multicyclic ring system of 6 to about 14 carbon atoms, preferably of 6 to about 10 carbon atoms. Representative aryl groups include phenyl and naphthyl. The term “arylene” refers to a group obtained by removal of a hydrogen atom from an aryl group. Non-limiting examples of arylene include phenylene and naphthylene.

The term “heteroaryl” means an aromatic monocyclic or multicyclic ring system of about 5 to about 14 ring atoms, preferably about 5 to about 10 ring atoms, in which one or more of the atoms in the ring system is/are element(s) other than carbon, for example, nitrogen, oxygen, or sulfur. In the case of multicyclic ring system, only one of the rings needs to be aromatic for the ring system to be defined as “Heteroaryl”. Preferred heteroaryls contain about 5 to 6 ring atoms. The prefix aza, oxa, thia, or thio before heteroaryl means that at least a nitrogen, oxygen, or sulfur atom, respectively, is present as a ring atom. A nitrogen atom of a heteroaryl is optionally oxidized to the corresponding N-oxide. Representative heteroaryls include pyridyl, 2-oxo-pyridinyl, pyrimidinyl, pyridazinyl, pyrazinyl, triazinyl, furanyl, pyrrolyl, thiophenyl, pyrazolyl, imidazolyl, oxazolyl, isoxazolyl, thiazolyl, isothiazolyl, triazolyl, oxadiazolyl, thiadiazolyl, tetrazolyl, indolyl, isoindolyl, benzofuranyl, benzothiophenyl, indolinyl, 2-oxoindolinyl, dihydrobenzofuranyl, dihydrobenzothiophenyl, indazolyl, benzimidazolyl, benzooxazolyl, benzothiazolyl, benzoisoxazolyl, benzoisothiazolyl, benzotriazolyl, benzo[1,3]dioxolyl, quinolinyl, isoquinolinyl, quinazolinyl, cinnolinyl, pthalazinyl, quinoxalinyl, 2,3-dihydro-benzo[1,4]dioxinyl, benzo[1,2,3]triazinyl, benzo[1,2,4]triazinyl, 4H-chromenyl, indolizinyl, quinolizinyl, 6aH-thieno[2,3-d]imidazolyl, 1H-pyrrolo[2,3-b]pyridinyl, imidazo[1,2-a]pyridinyl, pyrazolo[1,5-a]pyridinyl, [1,2,4]triazolo[4,3-a]pyridinyl, [1,2,4]triazolo[1,5-a]pyridinyl, thieno[2,3-b]furanyl, thieno[2,3-b]pyridinyl, thieno[3,2-b]pyridinyl, furo[2,3-b]pyridinyl, furo[3,2-b]pyridinyl, thieno[3,2-d]pyrimidinyl, furo[3,2-d]pyrimidinyl, thieno[2,3-b]pyrazinyl, imidazo[1,2-a]pyrazinyl, 5,6,7,8-tetrahydroimidazo[1,2-a]pyrazinyl, 6,7-dihydro-4H-pyrazolo[5,1-c][1,4]oxazinyl, 2-oxo-2,3-dihydrobenzo[d]oxazolyl, 3,3-dimethyl-2-oxoindolinyl, 2-oxo-2,3-dihydro-1H-pyrrolo[2,3-b]pyridinyl, benzo[c][1,2,5]oxadiazolyl, benzo[c][1,2,5]thiadiazolyl, 3,4-dihydro-2H-benzo[b][1,4]oxazinyl, 5,6,7,8-tetrahydro-[1,2,4]triazolo[4,3-a]pyrazinyl, [1,2,4]triazolo[4,3-a]pyrazinyl, 3-oxo-[1,2,4]triazolo[4,3-a]pyridin-2(3H)-yl, and the like. The term “heteroarylene” refers to a group obtained by removal of a hydrogen atom from a heteroaryl group. Exemplary heteroarylene groups include, but are not limited to, groups derived from the heteroaryl groups described above.

The term “non-aromatic heterocycle” or “non-aromatic heterocyclyl” means a non-aromatic monocyclic or multicyclic system containing 3 to 10 atoms, preferably 4 to about 7 carbon atoms, in which one or more of the atoms in the ring system is/are element(s) other than carbon, for example, nitrogen, oxygen, or sulfur. Representative non-aromatic heterocycle groups include pyrrolidinyl, 2-oxopyrrolidinyl, piperidinyl, 2-oxopiperidinyl, azepanyl, 2-oxoazepanyl, 2-oxooxazolidinyl, morpholino, 3-oxomorpholino, thiomorpholino, 1,1-dioxothiomorpholino, piperazinyl, tetrohydro-2H-oxazinyl, and the like. The term “non-aromatic heterocyclene” refers to a group obtained by removal of a hydrogen atom from a non-aromatic heterocyclyl group. Exemplary non-aromatic heterocyclene groups include, but are not limited to, groups derived from the non-aromatic heterocyclyl groups described above.

The term “monocyclic” used herein indicates a molecular structure having one ring.

The term “polycyclic” or “multi-cyclic” used herein indicates a molecular structure having two or more rings, including, but not limited to, fused, bridged, or spiro rings.

The term “phenyl” means a phenyl group as shown below

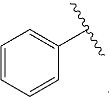 [SMILES: *c1ccccc1]

The term “substituted” or “substitution” of an atom means that one or more hydrogen on the designated atom is replaced with a selection from the indicated group, provided that the designated atom's normal valency is not exceeded.

“Unsubstituted” atoms bear all of the hydrogen atoms dictated by their valency. When a substituent is keto (i.e., ═O), then two hydrogens on the atom are replaced. Combinations of substituents and/or variables are permissible only if such combinations result in stable compounds; by “stable compound” or “stable structure” is meant a compound that is sufficiently robust to survive isolation to a useful degree of purity from a reaction mixture.

The term “optionally substituted” is used to indicate that a group may have a substituent at each substitutable atom of the group (including more than one substituent on a single atom), provided that the designated atom's normal valency is not exceeded and the identity of each substituent is independent of the others. Up to three H atoms in each residue are replaced with alkyl, halogen, haloalkyl, hydroxy, lower alkoxy, carboxy, carboalkoxy (also referred to as alkoxycarbonyl), carboxamido (also referred to as alkylaminocarbonyl), cyano, carbonyl, nitro, amino, alkylamino, dialkylamino, mercapto, alkylthio, sulfoxide, sulfone, acylamino, amidino, phenyl, benzyl, heteroaryl, phenoxy, benzyloxy, or heteroaryloxy.

Compounds described herein may contain one or more asymmetric centers and may thus give rise to enantiomers, diastereomers, and other stereoisomeric forms. Each chiral center may be defined, in terms of absolute stereochemistry, as (R)- or (S)-. When the compounds described herein contain olefinic double bonds or other centers of geometric asymmetry, and unless specified otherwise, it is intended that the compounds include both E and Z geometric isomers. Likewise, all tautomeric forms are also intended to be included.

The term “salts”, when used in relation to the compounds and polymers of the present application, means the organic acid addition salts and base addition salts of the compounds and polymers of the present application. Exemplary acid addition salts include the hydrobromide, hydrochloride, sulfate, bisulfate, phosphate, nitrate, acetate, oxalate, valerate, oleate, palmitate, stearate, laurate, borate, benzoate, lactate, phosphate, tosylate, citrate, maleate, fumarate, succinate, tartrate, naphthylate, mesylate, glucoheptonate, lactiobionate, sulphamates, malonates, salicylates, propionates, methylene-bis-b-hydroxynaphthoates, gentisates, isethionates, di-p-toluoyltartrates, methane-sulphonates, ethanesulphonates, benzenesulphonates, p-toluenesulphonates, cyclohexylsulphamates and quinateslaurylsulphonate salts, and the like. Suitable metal salts include the sodium, potassium, calcium, barium, zinc, magnesium, and aluminum salts.

The term “copolymer” refers to a polymer derived from more than one species of monomer.

The term “alternating copolymer” or “alternating polymer” refers to a copolymer consisting of two or more species of monomeric units that are arranged in an alternating sequence (in which every other building unit is different (-M₁M₂-)ₙ.

The term “random copolymer” or “random polymer” refers to a copolymer in which there is no definite order for the sequence of the different building blocks (-M₁M₂M₁M₁M₂M₁M₂M₂-).

The term “statistical copolymer” or “statistical polymer” refers to a copolymer in which the sequential distribution of the monomeric units obeys known statistical laws.

The term “block copolymer” or “block polymer” refers to a macromolecule consisting of long sequences of different repeat units. Exemplary block polymers include, but are not limited to AₙBₘ, AₙBₘAₘ, AₙBₘCₖ, or AₙBₘCₖAₙ.

The term “statistically defined manner” refers to the repeat unit sequence distribution (RUSD) of the polymer, which is determined by the polymerization chemistry, the number and nature of comonomers, and the reaction conditions under which the polymer is formed. For any polymer, the RUSD can be represented by a probability function Pᵢ(j) that indicates the likelihood that the identity of the repeat unit at location j along the chain contour is i. Common RUSD classifications include, but are not limited to, random (Pᵢ=constant) and block (e.g., Pᵢ(j<f)=0 and Pᵢ(j≥f)=given fixed contour coordinate f). RUSD prediction and measurement are discussed in most polymer chemistry texts, e.g Hiemenz and Lodge, Polymer Chemistry, 2^{nd} Ed., Boca Raton Fl. CRC Press (2007), which is hereby incorporated by reference in its entirety.

In some embodiments, the polymer according to the present application:

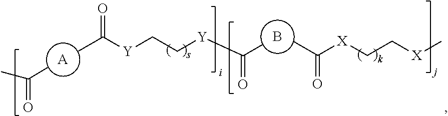

can further have one or more of the polymer blocks of formula

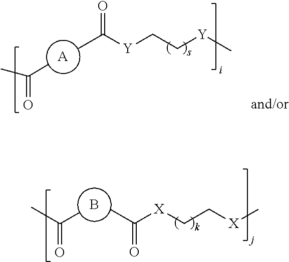

attached to the end of either or both sides of the polymer chain

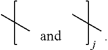

For example, the polymer according to the present application can have a structure of formula -Aᵢ-Bⱼ-, -Aᵢ-Bⱼ-Aᵢᵢ-Bⱼⱼ-, -Aᵢ-Bⱼ-Aᵢᵢ-Bⱼ-Aᵢᵢᵢ-Baⱼⱼⱼ-, -B-Aᵢ-Bⱼ-Aᵢᵢ-Bⱼ-Aᵢᵢᵢ-Bⱼⱼⱼ-, -B-Aᵢ- Bⱼ-A-Bⱼⱼ-Aᵢᵢᵢ-Bⱼⱼⱼ-, -B-Aᵢ-Bⱼ-A-B-Aᵢᵢᵢ-Bⱼⱼⱼ-, -Bⱼ-Aᵢ-Bⱼ-Aᵢᵢ-Bⱼ-Aᵢᵢᵢ-Bⱼⱼⱼ-, or -Aᵢ-Bⱼ-Aᵢᵢ-Bⱼ-Aᵢᵢᵢ-Bⱼⱼⱼ-A- , wherein

### A is

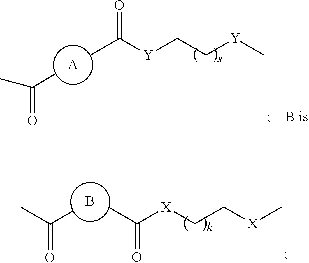

each i, ii, iii . . . iₖ can be the same or different and are independently selected from 1 to 1,000,000; each j, jj, jjj . . . jₘ can be the same or different and are independently selected from 1 to 1,000,000; k and m are 1,000,000; wherein the sum of i, ii, iii . . . iₖ is 1 to 1,000,000, and the sum of j, jj, jjj . . . jₘ is 1 to 1,000,000.

In one embodiment, the polymer is an alternating copolymer.

In another embodiment, the polymer is a random copolymer.

In another embodiment, the polymer is a statistical copolymer.

In yet another embodiment, the polymer is a block copolymer.

According to the present application, i is from 1 to 1,000,000. For example, i is from 2 to 1,000,000, i is from 10 to 1,000,000, i is from 20 to 1,000,000, i is from 25 to 1,000,000, i is from 30 to 1,000,000, i is from 40 to 1,000,000, i is from 50 to 1,000,000, i is from 75 to 1,000,000, i is from 100 to 1,000,000, i is from 150 to 1,000,000, i is from 200 to 1,000,000, i is from 250 to 1,000,000, i is from 300 to 1,000,000, i is from 350 to 1,000,000, i is from 400 to 1,000,000, i is from 450 to 1,000,000, i is from 500 to 1,000,000, i is from 550 to 1,000,000, i is from 600 to 1,000,000, i is from 650 to 1,000,000, i is from 700 to 1,000,000, i is from 750 to 1,000,000, i is from 800 to 1,000,000, i is from 850 to 1,000,000, i is from 900 to 1,000,000, i is from 950 to 1,000,000, i is from 1,000 to 1,000,000, i is from 1,500 to 1,000,000, i is from 2,000 to 1,000,000, i is from 3,000 to 1,000,000, i is from 4,000 to 1,000,000, i is from 5,000 to 1,000,000, i is from 6,000 to 1,000,000, i is from 7,000 to 1,000,000, i is from 8,000 to 1,000,000, i is from 9,000 to 1,000,000, i is from 10,000 to 1,000,000, i is from 20,000 to 1,000,000, i is from 30,000 to 1,000,000, i is from 40,000 to 1,000,000, i is from 50,000 to 1,000,000, i is from 100,000 to 1,000,000, i is from 250,000 to 1,000,000, i is from 500,000 to 1,000,000, i is from 750,000 to 1,000,000. For example, i is from 2 to 850,000, i is from 10 to 700,000, i is from 50 to 600,000, i is from 100 to 500,000, i is from 250 to 500,000, i is from 500 to 500,000, i is from 1,000 to 500,000, i is from 2,000 to 500,000, i is from 10,000 to 500,000, i is from 100,000 to 500,000.

According to the present application, j is from 1 to 1,000,000. For example, j is from 2 to 1,000,000, j is from 10 to 1,000,000, j is from 20 to 1,000,000, j is from 25 to 1,000,000, j is from 30 to 1,000,000, j is from 40 to 1,000,000, j is from 50 to 1,000,000, j is from 75 to 1,000,000, j is from 100 to 1,000,000, j is from 150 to 1,000,000, j is from 200 to 1,000,000, j is from 250 to 1,000,000, j is from 300 to 1,000,000, j is from 350 to 1,000,000, j is from 400 to 1,000,000, j is from 450 to 1,000,000, j is from 500 to 1,000,000, j is from 550 to 1,000,000, j is from 600 to 1,000,000, j is from 650 to 1,000,000, j is from 700 to 1,000,000, j is from 750 to 1,000,000, j is from 800 to 1,000,000, j is from 850 to 1,000,000, j is from 900 to 1,000,000, j is from 950 to 1,000,000, j is from 1,000 to 1,000,000, j is from 1,500 to 1,000,000, j is from 2,000 to 1,000,000, j is from 3,000 to 1,000,000, j is from 4,000 to 1,000,000, j is from 5,000 to 1,000,000, j is from 6,000 to 1,000,000, j is from 7,000 to 1,000,000, j is from 8,000 to 1,000,000, j is from 9,000 to 1,000,000, j is from 10,000 to 1,000,000, j is from 20,000 to 1,000,000, j is from 30,000 to 1,000,000, j is from 40,000 to 1,000,000, j is from 50,000 to 1,000,000, j is from 100,000 to 1,000,000, j is from 250,000 to 1,000,000, j is from 500,000 to 1,000,000, j is from 750,000 to 1,000,000. For example, j is from 2 to 850,000, j is from 10 to 700,000, j is from 50 to 600,000, j is from 100 to 500,000, j is from 250 to 500,000, j is from 500 to 500,000, j is from 1,000 to 500,000, j is from 2,000 to 500,000, j is from 10,000 to 500,000, j is from 100,000 to 500,000.

According to the present application, the polymer can have a number average molecular weight (M) above 1 kDa, above 2 kDa, above 3 kDa, above 4 kDa, above 5 kDa, above 6 kDa, above 7 kDa, above 8 kDa, above 9 kDa, above 10 kDa, above 11 kDa, above 12 kDa, above 13 kDa, above 14 kDa, above 15 kDa, above 16 kDa, above 17 kDa, above 18 kDa, above 19 kDa, above 20 kDa, above 21 kDa, above 22 kDa, above 23 kDa, above 24 kDa, above 25 kDa, above 26 kDa, above 27 kDa, above 28 kDa, above 29 kDa, or above 30 kDa.

According to the present application, the polymer can have a number average molecular weight (M) ranging from 0.1 kDa to 200 kDa. For example, the polymer can have a number average molecular weight (M) from 0.1 kDa to 40 kDa, from 0.5 kDa to 35 kDa, from 1 kDa to 35 kDa, from 2 kDa to 30 kDa, from 3 kDa to 30 kDa, from 4 kDa to 30 kDa, from 5 kDa to 30 kDa, from 6 kDa to 30 kDa, from 7 kDa to 30 kDa, from 8 kDa to 30 kDa, from 9 kDa to 30 kDa, from 10 kDa to 30 kDa, from 11 kDa to 30 kDa, from 12 kDa to 30 kDa, from 13 kDa to 30 kDa, from 14 kDa to 30 kDa, from 15 kDa to 30 kDa, from 2 kDa to 20 kDa, from 3 kDa to 20 kDa, from 4 kDa to 20 kDa, from 5 kDa to 20 kDa, from 6 kDa to 20 kDa, from 7 kDa to 20 kDa, from 8 kDa to 20 kDa, from 9 kDa to 20 kDa, from 10 kDa to 20 kDa, from 11 kDa to 20 kDa, from 12 kDa to 20 kDa, from 13 kDa to 20 kDa, from 14 kDa to 20 kDa, from 15 kDa to 20 kDa, from 2 kDa to 15 kDa, from 3 kDa to 15 kDa, from 4 kDa to 15 kDa, from 5 kDa to 15 kDa, from 6 kDa to 15 kDa, from 7 kDa to 15 kDa, from 8 kDa to 15 kDa, from 9 kDa to 15 kDa, from 10 kDa to 15 kDa, from 1 kDa to 10 kDa, from 2 kDa to 10 kDa, from 3 kDa to 10 kDa, from 4 kDa to 10 kDa, or from 5 kDa to 10 kDa.

In one embodiment, X is O.

In another embodiment, X is NH.

In one embodiment, Y is O.

In another embodiment, Y is NH.

In another embodiment,

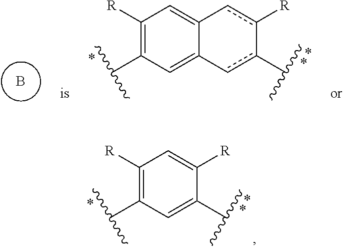

[symbol]

is a single or a double bond,

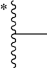

is a point of attachment of

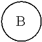

to —C(O) group, and

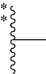

is a point of attachment of

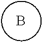

to —C(O)—X— group.

In one embodiment, the polymer comprises a moiety of formula:

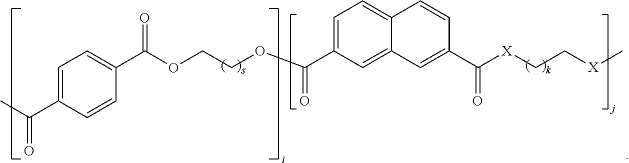

In another embodiment, the polymer comprises a moiety of formula:

In another embodiment, the polymer comprises a moiety of formula:

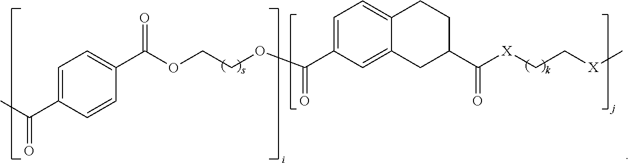

In a further embodiment, the polymer comprises a moiety of formula:

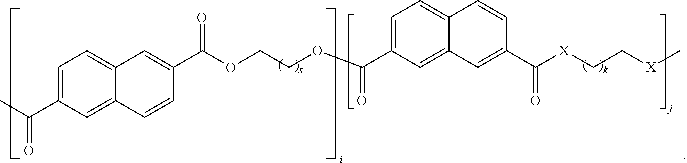

In yet another embodiment the polymer comprises a moiety of formula:

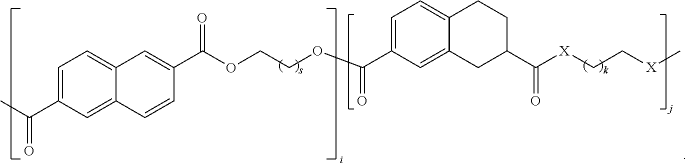

In another embodiment, the polymer comprises a moiety of formula:

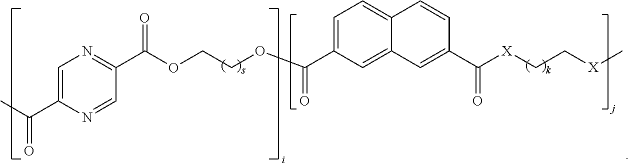

In a further embodiment, the polymer comprises a moiety of formula:

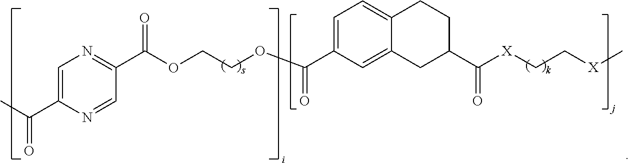

In yet another embodiment, the polymer comprises a moiety of formula:

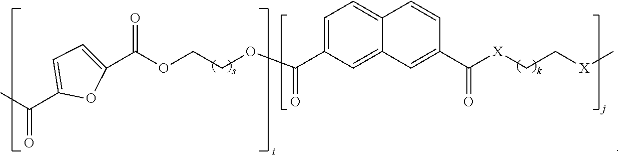

In another embodiment, the polymer comprises a moiety of formula:

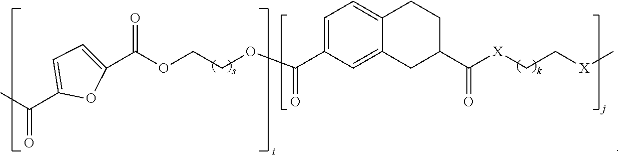

In another embodiment, the polymer comprises a moiety of formula:

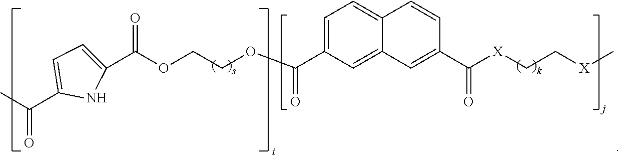

In yet another embodiment, the polymer comprises a moiety of formula:

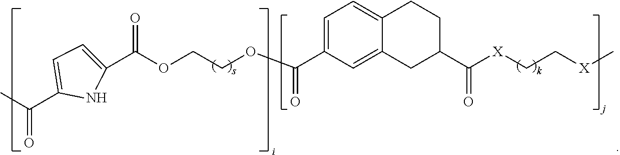

In a further embodiment, the polymer comprises a moiety of formula:

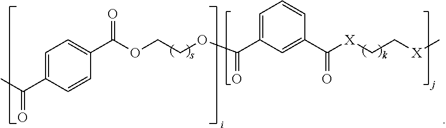

In yet another embodiment, the polymer comprises a moiety of formula:

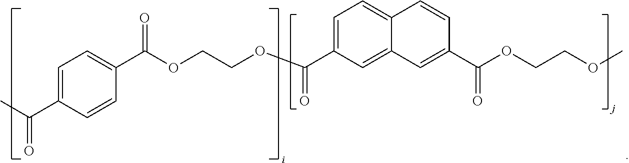

In yet another embodiment, the polymer comprises a moiety of formula:

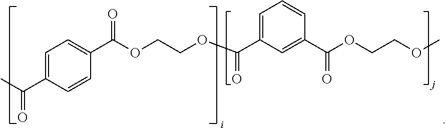

In some embodiments, the polymer has the structure of formula (I):

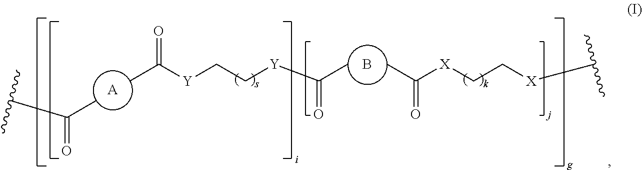

wherein

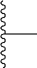

is a terminal group of the polymer;
g is 1 to 1,000;
each i is independently selected from 1 to 1,000,000; and
each j is independently selected from 1 to 1,000,000,
wherein the sum of i, i₂, i₃ . . . i_{g} is 1 to 1,000,000, and the sum of j₁, j₂, j₃ . . . j_{g} is 1 to 1,000,000.

According to the present application, g is from 1 to 1,000. For example, g is from 2 to 1,000, g is from 3 to 1,000, g is from 4 to 1,000, g is from 5 to 1,000, g is from 6 to 1,000, g is from 7 to 1,000, g is from 8 to 1,000, g is from 9 to 1,000, g is from 10 to 1,000, g is from 20 to 1,000, g is from 30 to 1,000, g is from 40 to 1,000, g is from 50 to 1,000, g is from 100 to 1,000, g is from 200 to 1,000, g is from 300 to 1,000, g is from 400 to 1,000, g is from 500 to 1,000, g is from 1 to 100, g is from 2 to 100, g is from 3 to 100, g is from 4 to 100, g is from 5 to 100, g is from 6 to 100, g is from 7 to 100, g is from 8 to 100, i is from 9 to 100, g is from 10 to 100, or g is from 1 to 10.

In some embodiments, g is 1.

In one embodiment, the polymer has the structure of formula (Ia):

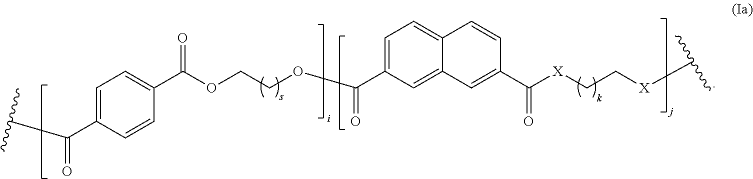

In another embodiment, the polymer has the structure of formula (Ib):

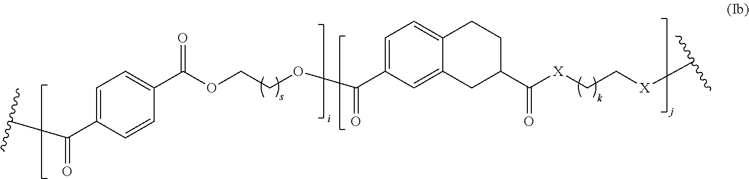

In another embodiment, the polymer has the structure of formula (Ic):

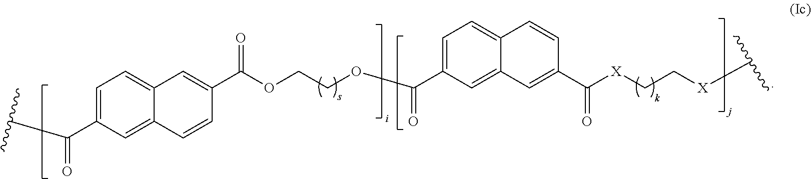

In a further embodiment, the polymer has the structure of formula (Id):

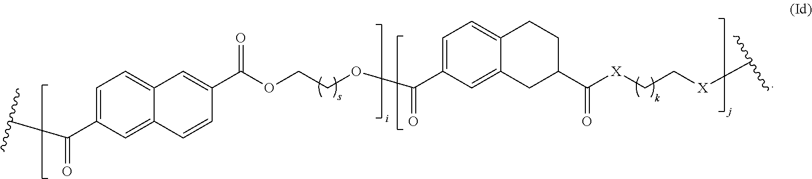

In yet another embodiment, the polymer has the structure of formula (Ie):

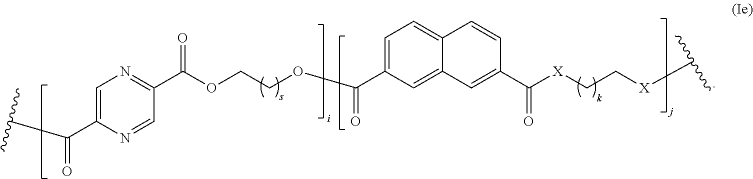

In another embodiment, the polymer has the structure of formula (If):

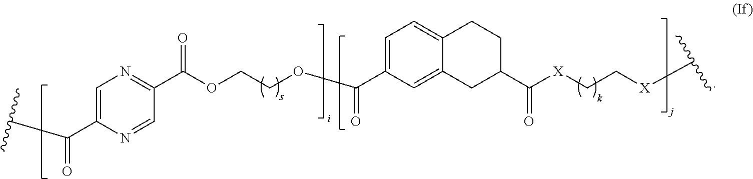

In a further embodiment, the polymer has the structure of formula (Ig):

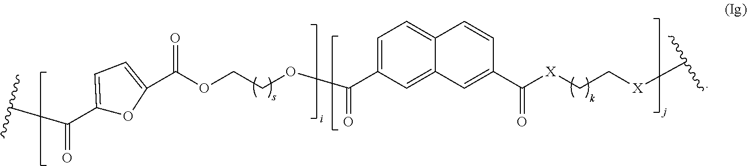

In yet another embodiment, the polymer has the structure of formula (Ih):

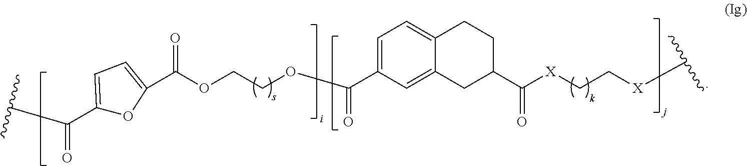

In another embodiment, the polymer has the structure of formula (Ii):

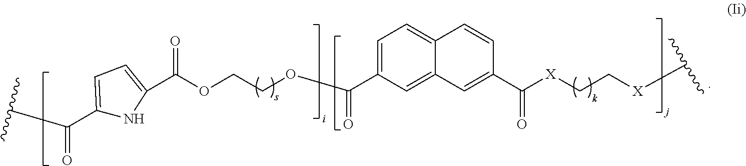

In yet another embodiment, the polymer has the structure of formula (Ij):

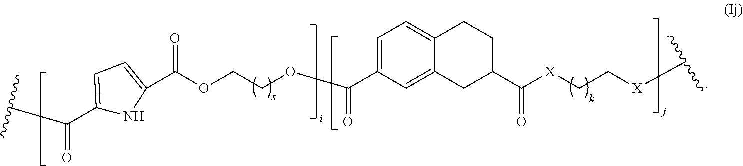

In a further embodiment, the polymer has the structure of formula (Ik):

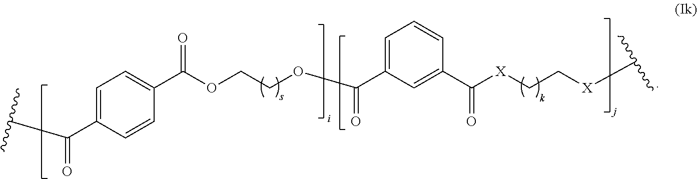

In yet another embodiment, the polymer has the structure of formula (Ia′):

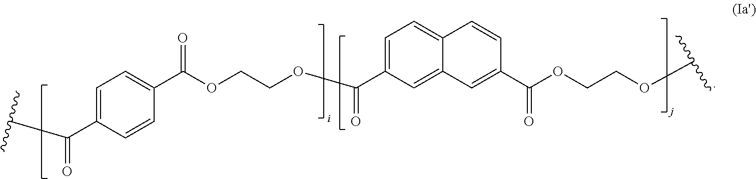

In yet another embodiment, the polymer has the structure of formula (Ik′):

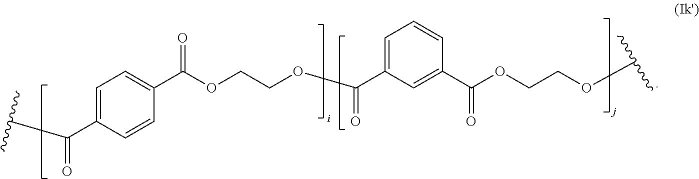

In at least one embodiment, the has the structure of formula:

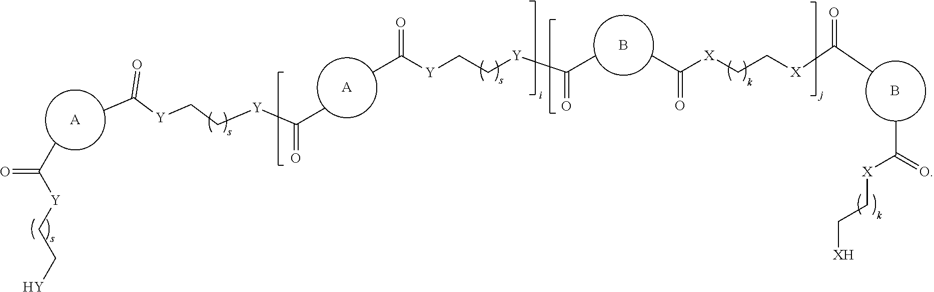

The polymers of the present application can be prepared according to the schemes 1-8 described below.

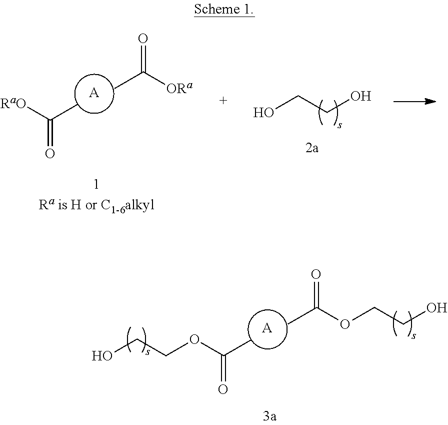

Initial esterification/transesterification reaction between compound 1 and diol 2a leads to formation of compound 3a. This reaction can be carried out neat or in a variety of solvents, for example in water, methanol (MeOH), ethanol (EtOH), isopropanol (i-PrOH), dimethylformamide (DMF), or other such solvents or in a mixture of such solvents. This reaction can be carried out at a temperature of 20° C. to 300° C., at a temperature of 40° C. to 250° C., or at a temperature of 100° C. to 250° C.

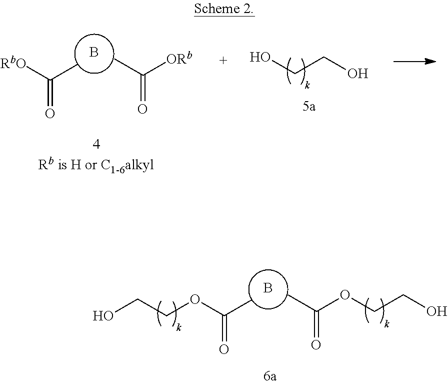

The reaction between compounds 4 and diol 5a leads to formation of compound 6a. This reaction can be carried out neat or in a variety of solvents, for example in water, methanol (MeOH), ethanol (EtOH), isopropanol (i-PrOH), dimethylformamide (DMF), or other such solvents or in a mixture of such solvents. This reaction can be carried out at a temperature of 20° C. to 300° C., at a temperature of 40° C. to 250° C., or at a temperature of 100° C. to 250° C.

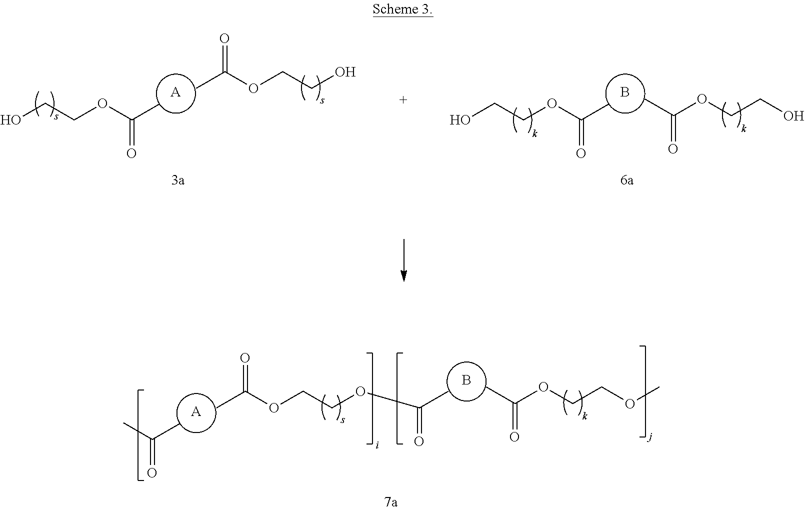

Polymers of formula 7a can be prepared by an initial polycondensation reaction (oligomer formation) between compounds 3a and 6a followed by a polymerization step (polymer formation) (Scheme 3). The initial polycondensation reaction (oligomer formation) can be carried out neat or in a variety of solvents, for example in water, methanol (MeOH), ethanol (EtOH), isopropanol (i-PrOH), dimethylformamide (DMF), or other such solvents or in a mixture of such solvents. The initial polycondensation reaction (oligomer formation) can be carried out at a temperature of 0° C. to 150° C., at a temperature of 40° C. to 90° C., or at a temperature of 50° C. to 70° C. The polymer formation step can be performed neat or in a variety of solvents, for example in phenols, cresols, hexafluoro-isopropanol, dimethylformamide (DMF) or other such solvents or in a mixture of such solvents. The final step in the polymerization (polymer formation) reaction can be carried out at a temperature of 20° C. to 400° C., at a temperature of 100° C. to 300° C., or at a temperature of 200° C. to 300° C.

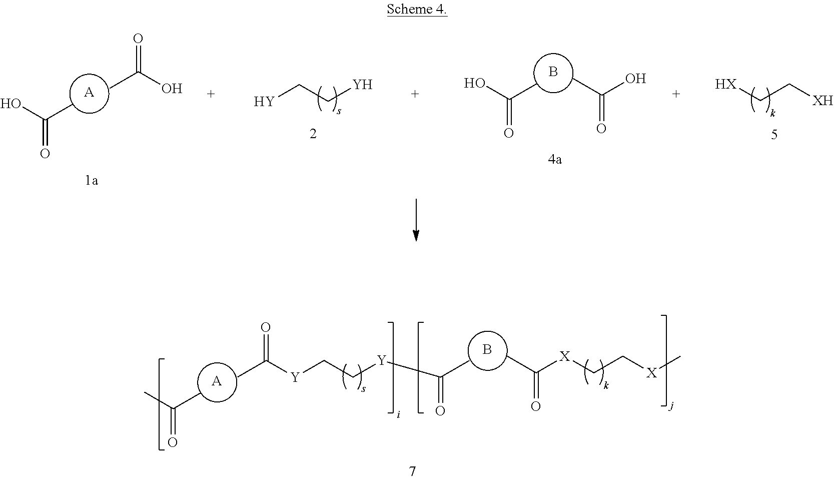

Polymers of formula 7 can be prepared by an initial polycondensation reaction (oligomer formation) between compounds 1a, 2, 4a, and 5 followed by a polymerization step (polymer formation) (Scheme 4). The initial polycondensation reaction can be carried out neat or in a variety of solvents, for example in water, methanol (MeOH), ethanol (EtOH), isopropanol (i-PrOH), dimethylformamide (DMF), or other such solvents or in a mixture of such solvents. The initial polycondensation reaction (oligomer formation) can be carried out at a temperature of 100° C. to 300° C., at a temperature of 125° C. to 275° C., at a temperature of 150° C. to 250° C., at a temperature of 175° C. to 250° C., at a temperature of 200° C. to 250° C., or at a temperature of 200° C. to 240° C. The polymer formation step can be performed neat or in a variety of solvents, for example in phenols, cresols, hexafluoro-isopropanol, dimethylformamide (DMF) or other such solvents or in a mixture of such solvents. The final step in the polymerization (polymer formation) reaction can be carried out at a temperature of 100° C. to 400° C., at a temperature of 125° C. to 375° C., at a temperature of 150° C. to 350° C., at a temperature of 175° C. to 325° C., at a temperature of 200° C. to 300° C., at a temperature of 225° C. to 300° C., at a temperature of 250° C. to 300° C., or at a temperature of 260° C. to 300° C.

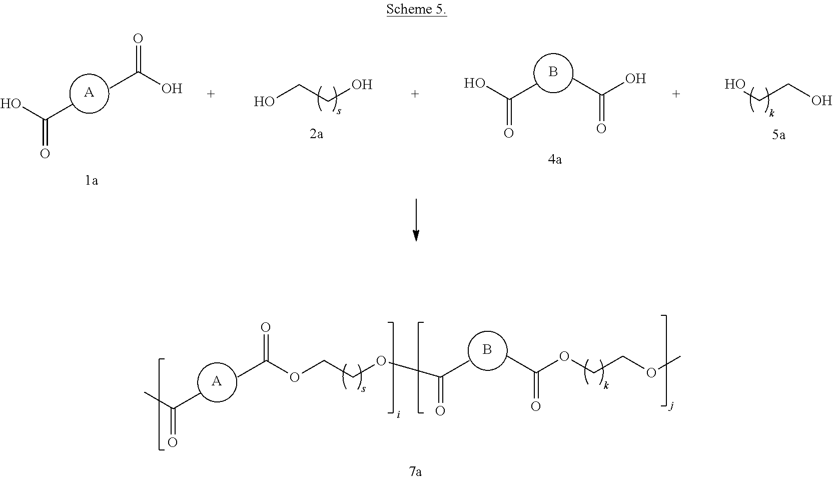

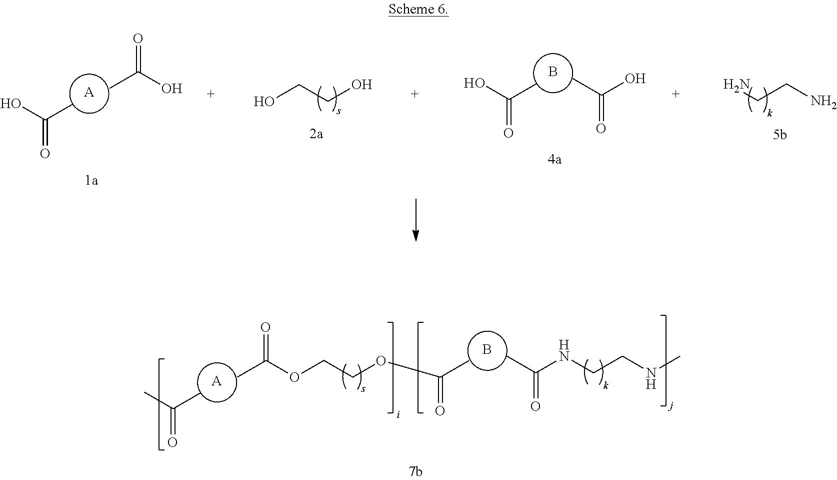

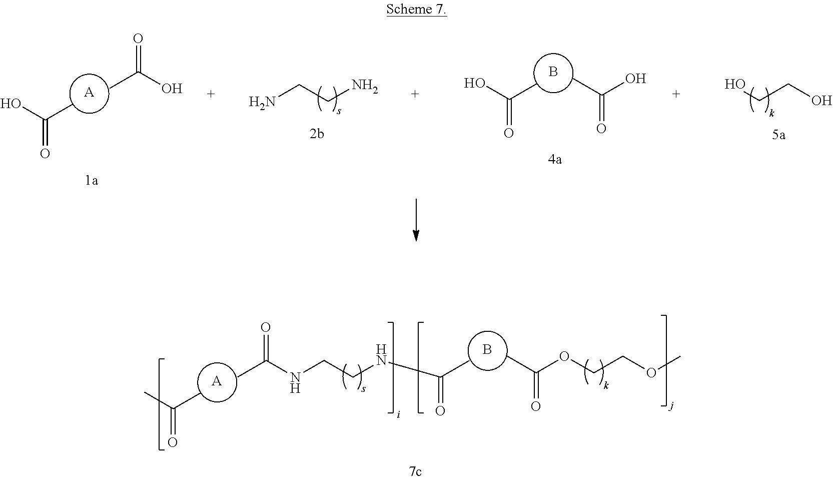

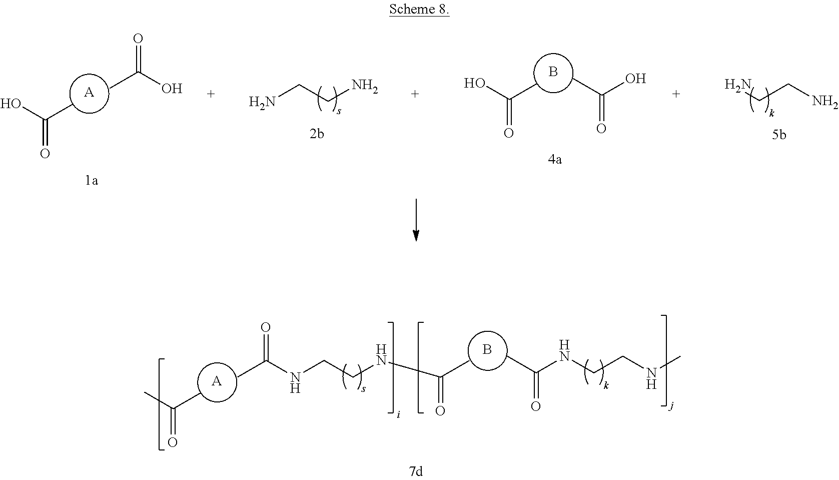

The polymers of formula 7 (7a-7d) can also be prepared by first preparing the salt between acid 1a and the compound of formula 2 (2a or 2b) (salt 1) and acid 4a and the compound of formula 5 (5a or 5b) (salt 2), followed by an initial polycondensation reaction (oligomer formation) and then a polymerization step. The salt formation can be carried out in a variety of solvents, for example in water, methanol (MeOH), ethanol (EtOH), isopropanol (i-PrOH), dimethylformamide (DMF), or other such solvents or in a mixture of such solvents. The salt formation can be carried out at a temperature of 20° C. to 100° C., at a temperature of 20° C. to 75° C., at a temperature of 20° C. to 50° C., at a temperature of 20° C. to 45° C., at a temperature of 20° C. to 40° C., at a temperature of 25° C. to 40° C., at a temperature of 30° C. to 40° C., at a temperature of 35° C. to 40° C., or at a temperature of 30° C. to 45° C. The salt formation can be carried out for 10 min to 24 hours, for 20 min to 20 hours, for 30 min to 18 hours, for 45 min to 12 hours, for 1 hour to 6 hours, or for 1 hour to 3 hours. The polycondensation reaction can be carried out neat or in a variety of solvents, for example in water, methanol (MeOH), ethanol (EtOH), isopropanol (i-PrOH), dimethylformamide (DMF), or other such solvents or in a mixture of such solvents. The initial polycondensation reaction can be carried out at a temperature of 100° C. to 300° C., at a temperature of 125° C. to 275° C., at a temperature of 150° C. to 250° C., at a temperature of 175° C. to 250° C., at a temperature of 200° C. to 250° C., or at a temperature of 200° C. to 240° C. The polymer formation step can be performed neat or in a variety of solvents, for example in phenols, cresols, hexafluoro-isopropanol, dimethylformamide (DMF) or other such solvents or in a mixture of such solvents. The final step in the polymerization (polymer formation) reaction can be carried out at a temperature of 100° C. to 400° C., at a temperature of 125° C. to 375° C., at a temperature of 150° C. to 350° C., at a temperature of 175° C. to 325° C., at a temperature of 200° C. to 300° C., at a temperature of 225° C. to 300° C., at a temperature of 250° C. to 300° C., or at a temperature of 260° C. to 300° C.

Polycondensation reaction and polymer formation step can be performed in the same reaction vessel or different reaction vessels. In some embodiments, the reaction vessel was vented at least once during the process of polycondensation reaction and polymer formation step.

In some embodiments, polycondensation reaction and polymer formation step can be performed under an inert atmosphere (e.g., under a nitrogen atmosphere or an argon atmosphere).

In some embodiments, polycondensation reaction and polymer formation step can be performed under pressure. For example, the polycondensation reaction and polymer formation step can be performed at a pressure for the inert gas from 50 psig to 300 psig, from 75 psig to 250 psig, from 100 psig to 200 psig, or from 125 psig to 200 psig. In other embodiments, polycondensation reaction and polymer formation step can be performed under atmospheric pressure. In other embodiments, the polycondensation reaction and polymer formation step can be performed under vacuum.

Another aspect of the present application relates to a process for preparation of a polymer comprising a moiety of formula:

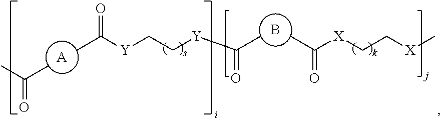

wherein

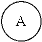

is monocyclic or bicyclic arylene, monocyclic or bicyclic heteroarylene, or monocyclic or bicyclic non-aromatic heterocyclene;

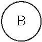

is monocyclic or bicyclic arylene, monocyclic or bicyclic heteroarylene, or monocyclic or bicyclic non-aromatic heterocyclene, wherein monocyclic or bicyclic arylene, monocyclic or bicyclic heteroarylene, or monocyclic or bicyclic non-aromatic heterocyclene can be optionally substituted from 1 to 3 times with R;
X is NH or O;
Y is NH or O;
R is independently selected at each occurrence thereof from the group consisting of H, OH, and —OR′;
R′ is C₁₋₂₀ alkyl, C₂₋₂₀ alkenyl, or C₂₋₂₀ alkynyl;
s is 1 to 21;
k is 1 to 21;
i and j represent number average degrees of polymerization for repeat units of formula I that are distributed throughout the polymer chain in a statistically defined manner;
i is 1 to 1,000,000; and
j is 1 to 1,000,000;
or a salt thereof.
   This process comprises:
providing a compound having the structure of formula (IV):

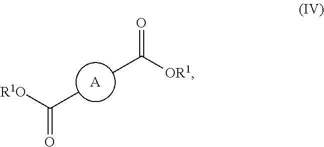

wherein R¹ is H or C₁₋₆ alkyl;
providing a compound having the structure of formula (V:

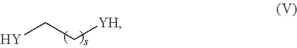

or a salt thereof,
providing a compound having the structure of formula (VI):

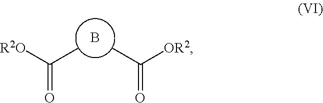

wherein R² is H or C₁₋₆ alkyl;
providing a compound having the structure of formula (VII):

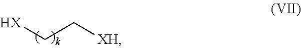

or a salt thereof, and
reacting the compound of formula (IV), the compound of formula (V), the compound of formula (VI), and the compound of formula (VII) under conditions effective to produce the polymer.

In one embodiment, the step of reacting the compound of formula (IV), the compound of formula (V), the compound of formula (VI), and the compound of formula (VII) comprises:
reacting the compound of formula (IV) with the compound of formula (V) to form a salt 1;
reacting the compound of formula (VI) with the compound of formula (VII) to form a salt 2; and
reacting the salt 1 with the salt 2 under conditions effective to produce the polymer.

In another embodiment, the step of reacting the salt 1 with the salt 2 comprises heating the salt 1 with the salt 2 under inert atmosphere in a reaction vessel. In one embodiment, the heating process is conducted under pressure. In some embodiments, the reaction vessel is vented at least once during said heating process.

During the process of making a polymer according to the present application, salt 1 and salt 2 can be used in any amount from 1 to 99%. In some embodiments, salt 1 and salt 2 are mixed at the ratio of 5% of salt 1 and 95% of salt 2, 10% of salt 1 and 90% of salt 2, 15% of salt 1 and 85% of salt 2, 20% of salt 1 and 80% of salt 2, 25% of salt 1 and 75% of salt 2, 30% of salt 1 and 70% of salt 2, 35% of salt 1 and 65% of salt 2, 40% of salt 1 and 60% of salt 2, 45% of salt 1 and 55% of salt 2, 50% of salt 1 and 50% of salt 2, 55% of salt 1 and 45% of salt 2, 60% of salt 1 and 40% of salt 2, 65% of salt 1 and 35% of salt 2, 70% of salt 1 and 30% of salt 2, 75% of salt 1 and 25% of salt 2, 80% of salt 1 and 20% of salt 2, 85% of salt 1 and 15% of salt 2, 90% of salt 1 and 10% of salt 2, or 95% of salt 1 and 5% of salt 2.

According to the present application, the compound of formula (IV), the compound of formula (V), the compound of formula (VI), and the compound of formula (VII) can be reacted in any suitable solvent or without the solvent. This reaction can be performed in water, methanol (MeOH), ethanol (EtOH), isopropanol (i-PrOH), dimethylformamide (DMF), acetone, methyl ethyl ketone (MEK), ethyl acetate, THF, or diethyl ether or other such solvents or in a mixture of such solvents. Preferably, the compound of formula (IV), the compound of formula (V), the compound of formula (VI), and the compound of formula (VII) are reacted in the presence of water.

According to the present application, the compound of formula (IV), the compound of formula (V), the compound of formula (VI), and the compound of formula (VII) can be reacted under pressure. For example, the compound of formula (IV), the compound of formula (V), the compound of formula (VI), and the compound of formula (VII) can be reacted under pressure of 10 to 1000 psig, 15 to 1000 psig, 20 to 900 psig, 30 to 800 psig, 40 to 700 psig, 50 to 600 psig, 50 to 500 psig, 60 to 500 psig, 70 to 500 psig, 80 to 500 psig, 90 to 500 psig, 100 to 500 psig, 110 to 500 psig, 120 to 500 psig, 130 to 500 psig, 140 to 500 psig, 150 to 500 psig, 160 to 500 psig, 170 to 500 psig, 180 to 500 psig, 190 to 500 psig, 200 to 500 psig, 210 to 500 psig, 220 to 500 psig, 230 to 500 psig, 240 to 500 psig, 250 to 500 psig, 260 to 500 psig, 270 to 500 psig, 280 to 500 psig, 290 to 500 psig, 300 to 500 psig, 100 to 400 psig, 110 to 400 psig, 120 to 400 psig, 130 to 400 psig, 140 to 400 psig, 150 to 400 psig, 160 to 400 psig, 170 to 400 psig, 180 to 400 psig, 190 to 400 psig, 200 to 400 psig, 210 to 400 psig, 220 to 400 psig, 230 to 400 psig, 240 to 400 psig, 250 to 400 psig, 260 to 400 psig, 270 to 400 psig, 280 to 400 psig, 290 to 400 psig, 300 to 400 psig, 100 to 350 psig, 110 to 350 psig, 120 to 350 psig, 130 to 350 psig, 140 to 350 psig, 150 to 350 psig, 160 to 350 psig, 170 to 350 psig, 180 to 350 psig, 190 to 350 psig, 200 to 350 psig, 210 to 350 psig, 220 to 350 psig, 230 to 350 psig, 240 to 350 psig, 250 to 350 psig, 260 to 350 psig, 270 to 350 psig, 280 to 350 psig, 290 to 350 psig, or 300 to 350 psig.

In some embodiments, the compound of formula (IV), the compound of formula (V), the compound of formula (VI), and the compound of formula (VII) are reacted under vacuum.

In one embodiment, the compound of formula (IV) is terephthalic acid.

In another embodiment, the compound of formula (V) is ethylene glycol.

In another embodiment, the compound of formula (VI) is dimethyl naphthalene-2,7-dicarboxylate.

In yet another embodiment, the compound of formula (VI) is isophthalic acid.

In a further embodiment, the compound of formula (VII) is ethylene glycol.

In yet another embodiment, the compound of formula (IV) is terephthalic acid, the compound of formula (V) is ethylene glycol, the compound of formula (VI) is isophthalic acid, and the compound of formula (VII) is ethylene glycol.

In another embodiment, the compound of formula (IV) is terephthalic acid, the compound of formula (V) is ethylene glycol, the compound of formula (VI) is dimethyl naphthalene-2,7-dicarboxylate, and the compound of formula (VII) is ethylene glycol.

In one embodiment, the polymer has the structure of formula (I):

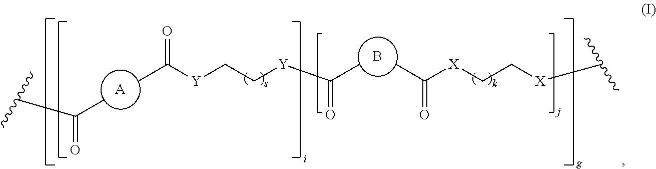

wherein

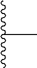

is a terminal group of the polymer;
g is 1 to 1,000;
each i is independently selected from 1 to 1,000,000; and
each j is independently selected from 1 to 1,000,000,
wherein the sum of i, i₂, i₃ . . . i_{g} is 1 to 1,000,000, and the sum of j, j₂, j₃ . . . j_{g} is 1 to 1,000,000.

Another aspect of the present application relates to a process for preparation of a polymer comprising a moiety of formula:

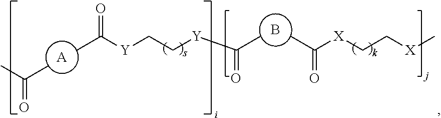

where

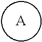

is monocyclic or bicyclic arylene, monocyclic or bicyclic heteroarylene, or monocyclic or bicyclic non-aromatic heterocyclene;

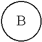

is monocyclic or bicyclic arylene, monocyclic or bicyclic heteroarylene, or monocyclic or bicyclic non-aromatic heterocyclene, wherein monocyclic or bicyclic arylene, monocyclic or bicyclic heteroarylene, or monocyclic or bicyclic non-aromatic heterocyclene can be optionally substituted from 1 to 3 times with R;
X is NH or O;
Y is NH or O;
R is independently selected at each occurrence thereof from the group consisting of H, OH, and —OR′;
R′ is C₁₋₂₀ alkyl, C₂₋₂₀ alkenyl, or C₂₋₂₀ alkynyl;
s is 1 to 21;
k is 1 to 21;
i and j represent number average degrees of polymerization for repeat units of formula I that are distributed throughout the polymer chain in a statistically defined manner;
i is 1 to 1,000,000; and
j is 1 to 1,000,000;
or a salt thereof.

This process comprises:
providing a compound having the structure of formula (II):

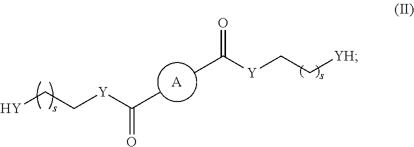

providing a compound having the structure of formula (III):

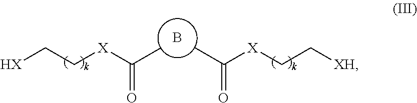

or a salt thereof, and
reacting the compound of formula (II) with the compound of formula (III) under conditions effective to produce the polymer.

In one embodiment, the compound of formula (II) is reacted with the compound of formula (III) in the presence of a catalyst. Suitable catalysts that can be used are catalysts conventionally used in polycondensation reactions, such as oxides or salts of silicon, aluminum, zirconium, titanium, cobalt, and combinations thereof. In some examples, antimony (III) oxide is used as a polycondensation catalyst. Preferably, the catalyst is selected from a group consisting of Sb₂O₃, GeO₂, titanium(IV) butoxide, titanium(IV) isopropoxide, di-butyl tin laurate, and SnCl₂.

In another embodiment, the compound of formula (II) is reacted with the compound of formula (III) under vacuum.

In another embodiment, the compound of formula (II) is reacted with the compound of formula (III) at a temperature above 100° C. Preferably, the compound of formula (II) is reacted with the compound of formula (III) at a temperature from about 100° C. to about 500° C., from about 150° C. to about 450°, from about 150° C. to about 400°, from about 200° C. to about 350°, from about 200° C. to about 300°, from about 250° C. to about 300°, or from about 200° C. to about 350°. More preferably, the compound of formula (II) is reacted with the compound of formula (III) at a temperature from about 180° C. to about 350° C., from about 190° C. to about 340° C., from about 190° C. to about 330° C., from about 190° C. to about 320° C., from about 190° C. to about 310° C., from about 200° C. to about 300° C., from about 210° C. to about 300° C., from about 210° C. to about 290° C., from about 220° C. to about 290° C., from about 220° C. to about 280° C., from about 230° C. to about 280° C., from about 230° C. to about 270° C., from about 240° C. to about 270° C., from about 250° C. to about 270° C., or from about 250° C. to about 260° C.

In one embodiment, the compound of formula (II) has a structure of formula (IIa):

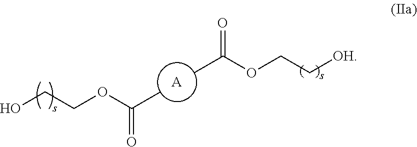

In another embodiment, the compound of formula (III) has a structure of formula (IIIa):

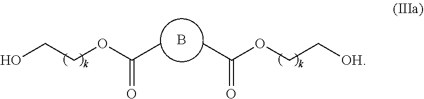

In at least one embodiment, the process further includes:
providing a compound having the structure of formula (IV):

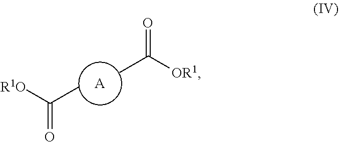

wherein R¹ is H or C₁₋₆ alkyl; and
forming the compound having the structure of formula (II) from the compound of formula (IV).

One embodiment relates to the process of the present application where said forming the compound having the structure of formula (II) comprises:
reacting the compound of formula (IV) with the compound of formula (V):

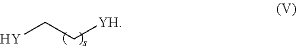

Another embodiment relates to the process of the present application where said forming the compound having the structure of formula (IIa) comprises:
reacting the compound of formula (IV) with the compound of formula (Va):

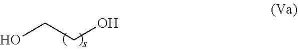

Yet another embodiment relates to the process of the present application where said providing a compound having the structure of formula (III) or a salt thereof comprises: providing a compound having the structure of formula (VI):

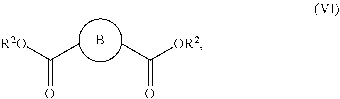

wherein R² is H or C₁₋₆ alkyl; and
forming the compound having the structure of formula (III) from the compound of formula (IV).

Yet another embodiment relates to the process of the present application where said forming the compound having the structure of formula (III) comprises:
reacting the compound of formula (VI) with the compound of formula (VII):

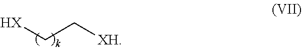

A further embodiment relates to the process of the present application where said forming the compound having the structure of formula (IIIa) comprises:
reacting the compound of formula (VI) with the compound of formula (VIIa):

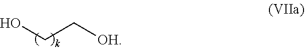

The compound of formula (VI) can be reacted with the compound of formula (VII) in the presence of a transesterification catalyst. Suitable transesterification catalyst that can be used are selected from the group consisting of zinc acetate (Zn(OAc)₂), manganese acetate (Mn(OAc)₂), cobalt acetate (Co(OAc)₂), lead acetate (Pb(OAc)₂), sodium acetate (NaOAc), and tin(II) chloride (SnCl₂).

In one embodiment the polymer has the structure of formula (I).

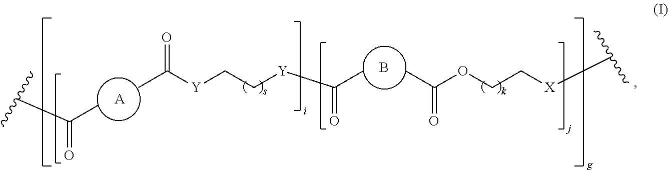

wherein

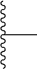

is a terminal group of the polymer;
g is 1 to 1,000;
each i is independently selected from 1 to 1,000,000; and
each j is independently selected from 1 to 1,000,000, wherein the sum of i, i₂, i₃ . . . i_{g} is 1 to 1,000,000, and the sum of j, j₂, j₃ . . . j_{g} is 1 to 1,000,000.

Another aspect of the present application relates to a packaging composition comprising the polymer of the present application.

In one embodiment, the packaging composition is vulcanized, cross-linked, compatibilized, and/or compounded with one or more other materials.

The above disclosure is general. A more specific description is provided below in the following examples. The examples are described solely for the purpose of illustration and are not intended to limit the scope of the present application. Changes in form and substitution of equivalents are contemplated as circumstances suggest or render expedient. Although specific terms have been employed herein, such terms are intended in a descriptive sense and not for purposes of limitation.

### EXAMPLES

The following Examples are presented to illustrate various aspects of the present application, but are not intended to limit the scope of the claimed application.

### Example 1—Materials and Methods

Terephthalic acid (TPA, 99+%, Acros Organics), isophthalic acid (IPA, 99+%, TCI America), and ethylene glycol (EG, anhydrous, 99.8%, Sigma-Aldrich) were purchased as the precursors for polymer synthesis. Dimethyl naphthalene-2,7-dicarboxylate (2,7-N) was synthesized according to the reaction procedures reported in Lee et al., “Next-Generation High-Performance Bio-Based Naphthalate Polymers Derived from Malic Acid for Sustainable Food Packaging,” ACS Sustainable Chemistry & Engineering 10:2624-2633 (2022), which is hereby incorporated by reference in its entirety. Zinc acetate (Zn(CH₃COO)₂), anhydrous, 99.8%, Alfa Aesar) and antimony(III) oxide (Sb₂O₃, 99%, Sigma-Aldrich) were used as catalysts in transesterification and polycondensation reaction, respectively. Triphenyl phosphate (TPP, >99%, Sigma-Aldrich) was used as a thermal stabilizer in polycondensation reaction. 1,1,1,3,3,3-Hexafluoro-2-propanol (HFIP), dichloroacetic acid (DCAA), phenol, 1,1,2,2-tetrachloroethane, trifluoroacetic acid-d (TFA-d), and chloroform-d (CDCl₃) were purchased from Fisher Scientific and were used as received for solvent and sample preparation.

### Example 2—Synthesis

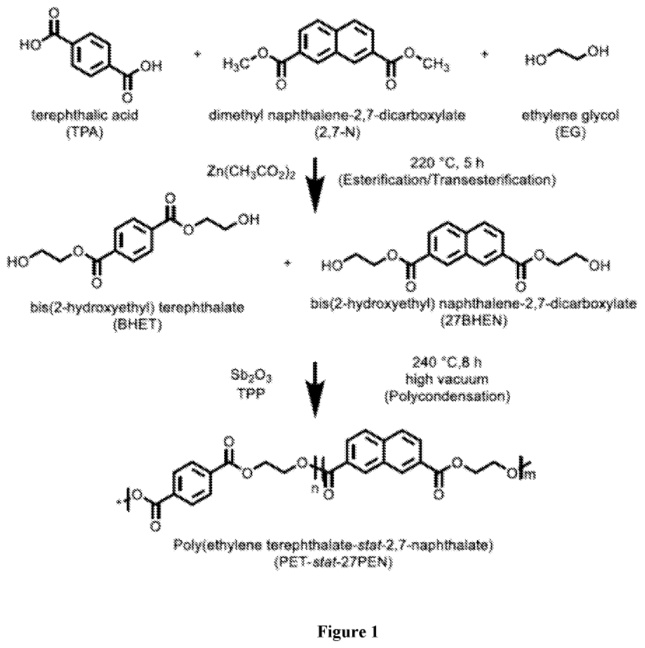

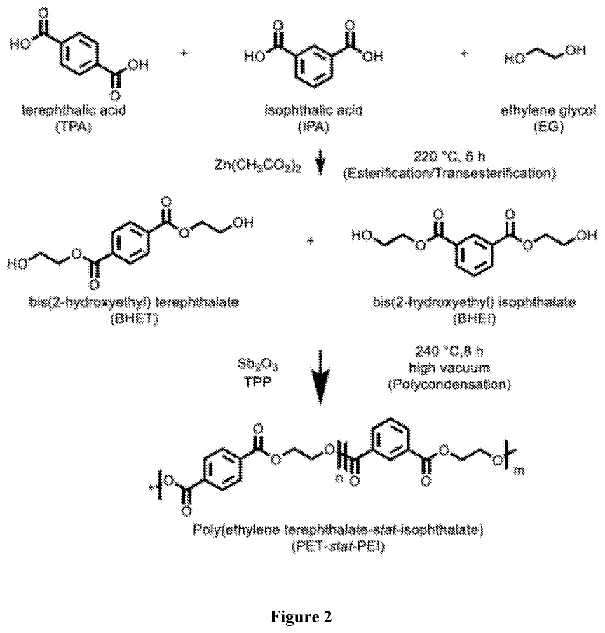

The homo- and copolymers were synthesized using a 300 ml stainless steel reactor (type 4560, Parr Instrument Company) equipped with mechanical stirrers, reactor controller (Model 4848, Parr Instrument Company), liquid nitrogen cold traps, and vacuum pump (DUO 10, Pfeiffer Vacuum). Poly(ethylene terephthalate-stat-2,7-naphthalate) (2,7-PENX) and poly(ethylene terephthalate-stat-isophthalate) (PEIX) were synthesized by a two-step polycondensation reaction (FIGS. 1-2). The first step was esterification as well as transesterification of TPA/2,7-N or TPA/IPA with EG, respectively, using Zn(CH₃COO)₂ (0.15 mol % to diester) as the transesterification catalyst. For TPA/IPA esterification, no catalyst was needed since diacid served as both reagent and catalyst (Reimschuessel, H. K., “Poly (Ethylene Terephthalate) Formation. Mechanistic and Kinetic Aspects of Direct Esterification Process,” Industrial & Engineering Chemistry Product Research and Development 19:117-125 (1980), which is hereby incorporated by reference in its entirety). The molar ratio of overall diacid/diester to EG was 1 to 10. The purpose of this molar ratio was to prepare completely bishydroxy ester end group monomers and ensure both end groups have the same reactivity toward other monomers. This will make the growth of polymer chain more consistent and lower the dispersity compared to the different end group monomers. The reaction mixture was purged with argon for 0.5 hours and heated to 220° C. The stirring speed was set at 250 rpm for 5 hours with the pressure at 110 psi and an argon sweep to remove water and methanol. After the first step reaction, the mixture was transferred to a round bottom flask and excess amount of EG were distilled under vacuum for 12 hours by using an oil bath set to 110° C. Then the monomer was returned to the autoclave reactor with antimony(III) oxide (0.02 mol % to the diacid/diester) and triphenyl phosphate (0.1 mol % to the diacid/diester) acting as catalyst and thermal stabilizer, respectively. The second step of polycondensation was carried out at 240° C. under high vacuum with the stirring speed at 600 rpm. At the end of the reaction, the reactor was purged by argon to ambient pressure to prevent thermal oxidation of the material while removing the polymer from the reactor.

### Example 3—Characterization

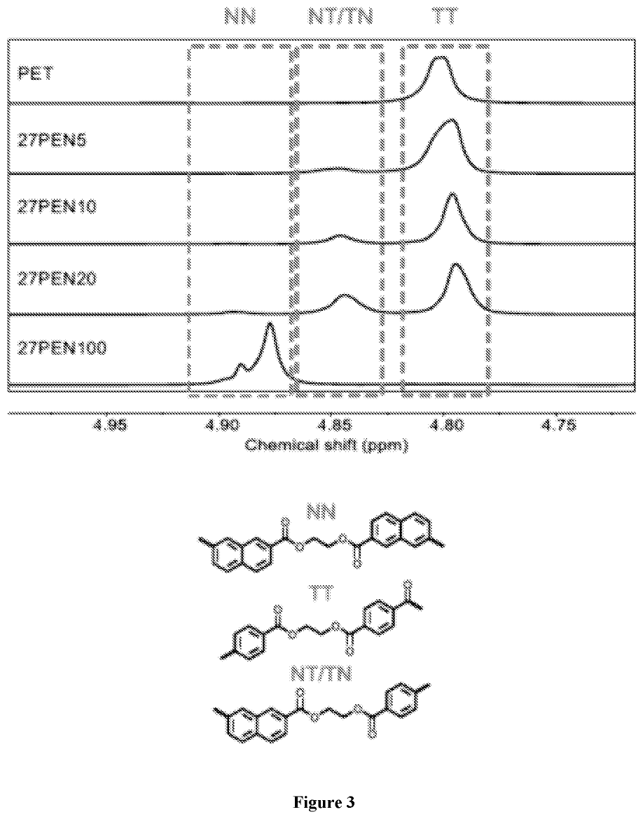

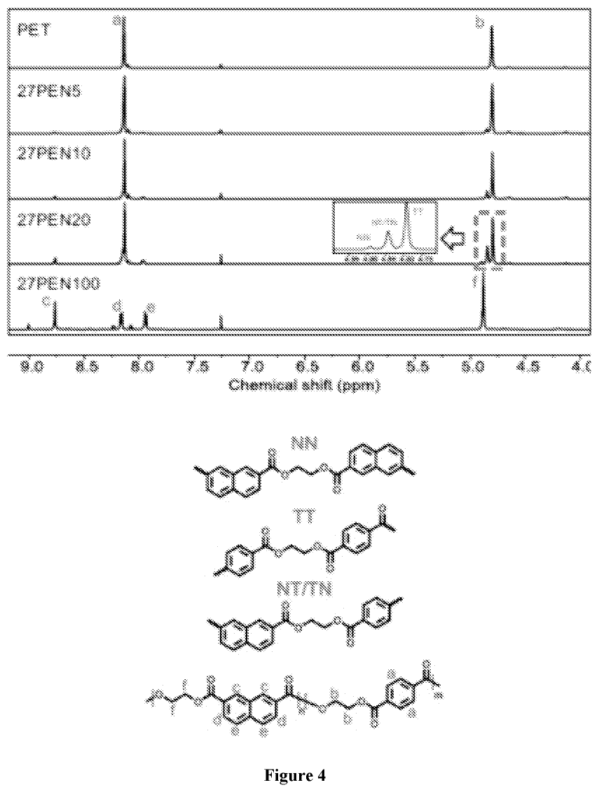

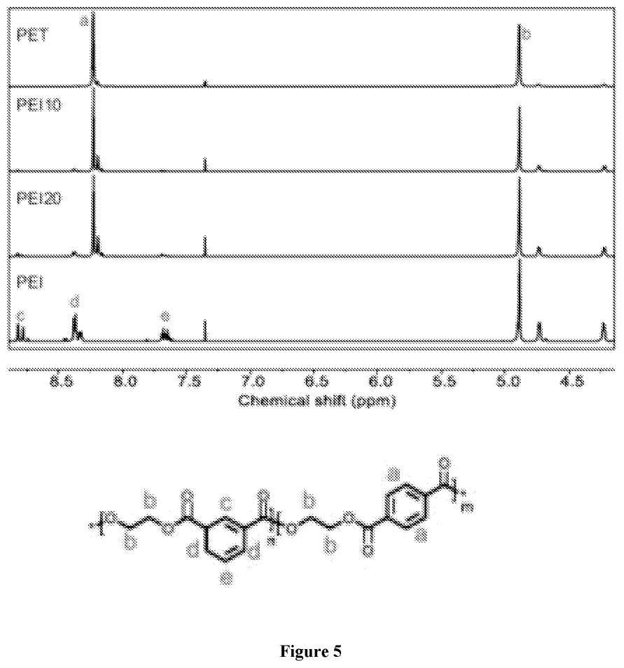

The composition and the chemical structures were determined by ¹H NMR (600 MHz, Bruker Avance III) in CDCl₃/TFA-d (75/25) solvent mixture at 10 mg/mL. FIGS. 3 and 4 show NMR spectra for PET and PET/PEN copolymers. PET and PET/PEI copolymer NMR spectra appear in FIG. 5.

The molar composition of the copolymers was calculated based on the integral intensities of peak a from PET units and peak c from 27PEN units by using the following equation:

$$E T = \frac{\frac{{1}_{α}}{4}}{\frac{{1}_{α}}{4} + \frac{{I}_{c}}{2}} E N = \frac{\frac{{l}_{c}}{2}}{\frac{{l}_{a}}{4} + \frac{{1}_{c}}{2}} \qquad ( Eq . 1 )$$

where the contents of ET and EN unit were their molar ratio in the polymer chain and Iₐ and I_{c} corresponded to the protons on the aromatic ring of ET and EN, respectively.

Intrinsic viscosity [η] measurement was performed in phenol/1,1,2,2-tetrachloroethane (60/40, v/v) solvent mixture at 25° C. water bath using an Ubbelohde viscometer (Xylem, type 537 13).

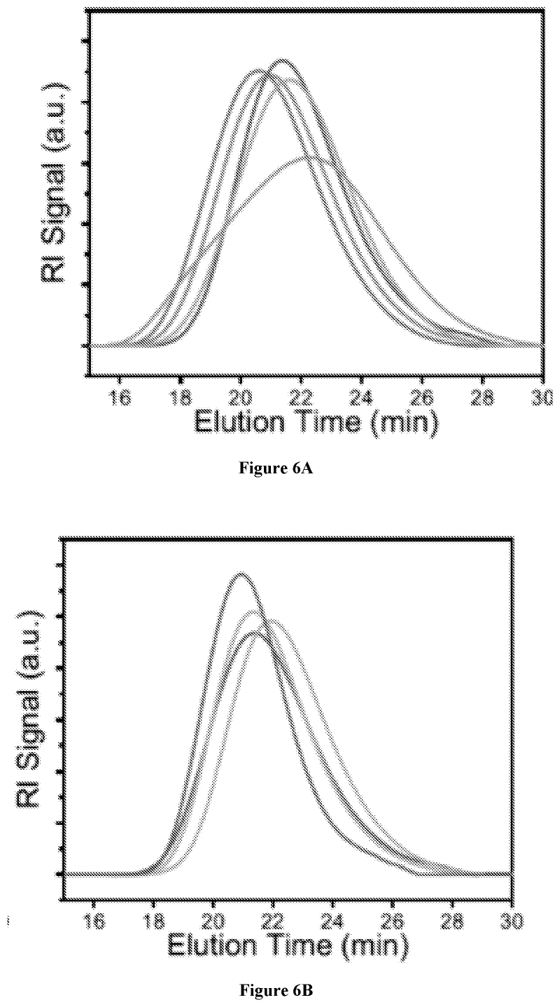

Gel permeation chromatography (GPC) measurements were performed at a flow rate of 0.3 mL/min in a Tosoh Ecosec GPC (Tosoh Ecosec HLC-8320GPC) equipped with UV and RI detector. The concentration of samples was 6 mg/mL in HFIP/DCAA (50/50, v/v) solvent mixture, and HFIP was used as an eluent. Poly(methyl methacrylate) (PMMA) standards were used to determine the molecular weights. The resultant chromatograms appear in FIG. 6A for PET and PET/PEN copolymers and in FIG. 6B for PET and PET/PEI copolymers.

FTIR (iD7 ATR Accessory for the Nicolet™ iS™ 5 Spectrometer, ThermoFisher) was used to analyze functionality. Spectra were obtained from 4000 to 400 cm⁻¹ from 32 scans at a resolution of 4 cm⁻¹.

The crystal structure morphology and the extent of crystallinity were characterized by a Xenocs Xeuss 2.0 S/WAXS system equipped with Cu Kα x-ray source. The data was collected by Dectris Pilatus3 R 1M detector and was calibrated by silver behenate standard. The specimens were attached directly onto the sample stage and the measurements were carried out under vacuum. Data acquisitions for WAXS and SAXS analysis were 600 s and 7200 s, respectively. The background signal of each sample was taken at the same condition. All data post-processing was done using Foxtrot 3.3.4 (SOLEIL Synchrotron, France) for 2D raw data reduction and absolute intensity correction, and Irena package (Advanced Photon Source, Argonne National Lab, USA) for profile combination (Ilavsky et al., “Irena: Tool Suite for Modeling and Analysis of Small-Angle Scattering,” Journal of Applied Crystallography 42:347-353 (2009), which is hereby incorporated by reference in its entirety). The crystal structure information was calculated by using scattering vector equation 2 and equation 3.

$$q = \frac{4 π}{λ} sin θ \qquad ( Eq . 2 )$$

$$L = \frac{2 π}{{q}_{m a x}} \qquad ( Eq . 3 )$$

$${X}_{c} = \frac{{A}_{c}}{{A}_{a} + {A}_{c}} * 100 \qquad ( Eq . 4 )$$

where λ is the X-ray wavelength for Cu Kα radiation (λ=1.542 Å), θ is Bragg's angle, and qₘₐₓ is peak position in the q range. The degree of crystallinity (X_{c}) was measured by equation 4 based on the ratio of the crystalline fraction (A_{c}) to the total area (Aₐ+A_{c}) under the WAXS curve.

The crystalline lamellar thickness (I_{c}) and amorphous lamellar thickness (Iₐ) in the lamellar stacks can be estimated from the WAXS and SAXS results using equation 5, where the amorphous region is assumed to be located only within the lamellar stacks.

I_{c}=LX_{c}, Iₐ=LXₐ (Eq. 5)

Thermal characterizations were conducted by using differential scanning calorimetry (DSC, TA instruments Q2500) under nitrogen. The specimens from injection molding were conducted from 25 to 300° C. (27PEN100 to 370° C.) at a rate of 10° C. min⁻¹, and were held for 5 min before being cooled back to 25° C. at a rate of 10° C. min-. The isothermal crystallization kinetics were carried out on completely amorphous tensile bar samples in the temperature range from 110 to 175° C. Samples were placed in DSC at 25° C. and heated to the desired temperature at 160° C. min-. They were kept at the crystallization temperature for a sufficient period until the completion of crystallization. Thermal stability was evaluated by a simultaneous thermal analyzer (STA 449 F1 Jupiter, NETZSCH) in the temperature range from 40 to 1000° C. at a rate of 10° C. min⁻¹ under nitrogen.

Tensile tests were performed by an Instron 3369 at room temperature with a 1 kN load cell and the speed of 10 mm-min⁻¹ following the standards of ISO 527-2. The dimension of the tensile bar is type 1BB with 2 mm (thickness)×10 mm (guage length). The impact strength of the samples were conducted by an impact tester (IT504, Tinius Olsen) according to the standards of ASTM D256 with the sample dimension of 63.5 mm (length)×12.7 mm (width)×3 mm (thickness).

The cryofractured surface were photographed by a scanning electron microscope (S4800 FE-SEM, Hitachi) at 10 kV SEM acceleration voltage. The samples from injection molding were freezed in liquid nitrogen for 5 min before being fractured.

The dynamic mechanical measurements were performed on a rheometer (ARES-G2, TA Instruments) using the torsion fixture at a constant frequency of 1 Hz and a strain of 0.1%. The testing was conducted from −120 to 200° C. at a heating rate of 5° C. min-.

The gas barrier property was measured by an oxygen permeation testing analyzer (MOCON's OX-TRAN Model 2/21) under carrier gas mixture of 98% nitrogen and 2% hydrogen, and test gas of 99.9% oxygen. The analysis procedure was based on ASTM D3985 standards. The specimens with 0.5 mm thickness were prepared via injection molding (HAAKE Minijet, ThermoFisher) at 270° C. into a 120° C. mold and quenched in cold water bath. The permeability of the films was measured via oxygen transmission at 23° C. under 1% relative humidity and 1 atm (Wang et al., “Highly Selective Mixed-Matrix Membranes with Layered Fillers for Molecular Separation,” Journal of Membrane Science 497:394-401 (2016); Wang et al., “Predictions of Effective Diffusivity of Mixed Matrix Membranes with Tubular Fillers,” Journal of Membrane Science 485:123-131 (2015), which are hereby incorporated by reference in their entirety).

### Example 4—Crystallization Kinetics Study of Naphthalate-Based Copolymers

The crystallization kinetics study was carried out in completely amorphous samples prepared by injection molding. The crystallization kinetics of PET and the copolymers under isothermal conditions for various modes of nucleation and growth can be well approximated based on the known Avrami equation. The general form of Equation 6 was:

Xₜ=1−exp(−ktⁿ) (Eq. 6)

where Xₜ was the relative crystallinity at time t, k was crystallization rate constant related to nucleation, and n was the Avrami exponent based on the mechanism of nucleation and the form of crystal growth. The Xₜ can be calculated according to Equation 7:

$${X}_{t} = \frac{{Q}_{t}}{{Q}_{∞}} = \frac{{\int }_{0}^{t} \frac{d H}{d t} d t}{{\int }_{0}^{∞} \frac{d H}{d t} d t} \qquad ( Eq . 7 )$$

where Qₜ and Q_{∞} were the amounts of enthalpy generated at time t and infinite time t∞, respectively, and dH/dt was the enthalpy evolution rate. For convenience, Equation 6 could be written in a double logarithmic form as follows Equation 8:

ln[−ln(1−Xₜ)]=n ln t+ln k (Eq. 8)

According to Equation 8, a graphic representation of −ln(1−Xₜ) versus ln t was developed, and n and l nk were the slope and the intercept of the straight line, respectively.

The crystallization half time (t_{1/2}) was defined as the time at which the relative crystallinity reached 50% and it can be determined according to the measured kinetic parameters by Equation 9:

$${t}_{1 / 2} = {( \frac{ln 2}{k} )}^{\frac{1}{n}} \qquad ( Eq . 9 )$$

### Example 5—Results and Discussion of Examples 1-4

A series of poly(ethylene terephthalate-stat-2,7-naphthalate) (27PENX) copolymers were prepared, where X denotes the molar 2,7-N composition (Table 1). Additionally, for comparison purposes an analogous series of poly(ethylene terephthalate-stat-isophthalate) (PEIX) with X as the isophthalate fraction were also considered (Table 2). PEIX and 27PENX are similar in that the meta-substituted aryl content is asymmetric with respect to the chain axis in both systems; they differ due to the two fused rings of the naphthalate vs. the single ring of the isophthalate. All polymers were produced using the two stage polymerization method and then were first characterized using gel permeation chromatography (GPC) and intrinsic viscosity (IV) to determine molecular weight distribution. The high D (3.61) of 27PEN100 is likely due to mass transport limitations, which resulted from the high viscosity during polymerization compared to that of PET and 27PEN copolymers, as mentioned in Lee et al., “Next-Generation High-Performance Bio-Based Naphthalate Polymers Derived from Malic Acid for Sustainable Food Packaging,” ACS Sustainable Chemistry & Engineering 10:2624-2633 (2022), which is hereby incorporated by reference in its entirety. The measured IV values of the polymers were consistent with the GPC results, and all polymers were within the range typical for industrially produced PET.

TABLE 1
Compositions and Characteristics of PET and Naphthalate-Based Copolymers

| | Temp./ | | | | | | | | |
|---|---|---|---|---|---|---|---|---|---|
| Sample | Time^{b} | IV^{c} | Mₙ^{d} | M_{w}^{e} | | [ET]/[EN] | ^{L}n | | |
| Code^{a} | (° C./hour) | (dL/g) | (kDa) | (kDa) | D^{f} | in polymer | ET^{h} | ^{L}n EN^{h} | DR^{h} |
| PET | 240/8 | 0.73 | 16.3 | 27.2 | 1.67 | 100/0 | — | — | — |
| 27PEN5 | 240/6 | 0.83 | 19.8 | 36.3 | 1.83 | 95.2/4.8 | 16.60 | 1.11 | 0.96 |
| 27PEN10 | 240/6 | 0.86 | 20.6 | 39.6 | 1.92 | 90.2/9.8 | 9.98 | 1.15 | 0.97 |
| 27PEN20 | 240/8 | 0.75 | 17.4 | 31.8 | 1.83 | 78.6/21.4 | 5.20 | 1.30 | 0.96 |
| 27PEN100^{g} | 240/3 | 0.48 | 11.9 | 42.9 | 3.61 | 0/100 | — | — | — |

^{a}Sample code: 27PENX, x = mol % of 2,7-N unit. ^{b}The esterification/transesterification reaction was carried out at 220° C. for 5 hours and bis-hydroxy ester monomer conversion of each precursor was ≥99%, which was determined by gas chromatography-mass spectrometry. ^{c}Intrinsic viscosity was measured in phenol/1,1,2,2- tetrachloroethane (60/40, v/v) solution by using an Ubbelohde viscometer at 25° C. ^{d}Number-average molecular weight. ^{e}Weight-average molecular weight. ^{f}Dispersity calculated by Mw/Mn. The molecular weights were determined by GPC in 1,1,1,3,3,3-hexafluoro-2-propanol solution with poly(methyl methacrylate) (PMMA) standards. ^{g}Poly(ethylene 2,7-naphthalate). ^{h}L_{nET} , L_{nEN}, and DR were measured by ¹H NMR analysis. Lₙ is the average number of MI monomer units that follow each other consecutively in a sequence uninterrupted by M2 units but bounded on each end of the sequence by M2 units. DR is a measure of the adjacency of monomers and their statistical distribution of the polymer sequence.

TABLE 2
Compositions and Characteristics
of Isophthalate-Based Copolymers

| Sample | Temp./Time | IV^{b} | Mₙ^{c} | M_{w}^{d} | |
|---|---|---|---|---|---|
| Code ^{a} | (° C./hour) | (dL/g) | (kDa) | (kDa) | Ð^{e} |
| PEI10 | 240/8 | 0.65 | 13.3 | 23.4 | 1.76 |
| PEI20 | 240/8 | 0.75 | 17.2 | 30.2 | 1.76 |
| PEI100 ^{f} | 240/8 | 0.55 | 23.4 | 37.3 | 1.59 |

^{a} Sample code: PEIX, x = mol % of IPA unit.
^{b}Intrinsic viscosity was measured in phenol/1,1,2,2-tetrachloroethane (60/40, v/v) solution by using an Ubbelohde viscometer at 25° C.
^{c}Number-average molecular weight.
^{d}Weight-average molecular weight.
^{e}Dispersity calculated by M_{w}/Mₙ. The molecular weights were determined by GPC in 1,1,1,3,3,3-hexafluoro-2-propanol solution with poly(methyl methacrylate) (PMMA) standards.
^{f} Poly(ethylene isophthalate).

Beyond molecular weight, chain architecture is a critical factor in properties of copolymers. It is well known that comonomers can have dramatically different reactivity ratios leading to heterogeneous monomer sequence distributions (MSDs). To determine the MSD, ¹H NMR was used to obtain information about the degree of randomness (DR), a useful heuristic in the description of copolymer microstructure. The number-average sequence lengths Lₙ of the ethylene terephthalate (ET) and ethylene naphthalate (EN), as well as DR, were estimated for each 27PENX copolymer by using the following equations (Paek et al., “Synthesis of a Series of Biodegradable Poly (Butylene Carbonate-Co-Isophthalate) Random Copolymers Derived from CO2-Based Comonomers for Sustainable Packaging,” Green Chemistry 22:4570-4580 (2020), which is hereby incorporated by reference in its entirety):

$${L}_{n E T} = 1 + \frac{2 {f}_{T T}}{{f}_{N T / T N}} , {L}_{n E N} = 1 + \frac{2 {f}_{N N}}{{f}_{N T / T N}} \qquad ( Eq . 10 )$$

$$D R = \frac{1}{{L}_{n E T}} + \frac{1}{{L}_{n E N}} \qquad ( Eq . 11 )$$

where the mole fraction of each dyad sequence including f_{NN}, f_{NT/TN}, and f_{TT} was calculated from the integral intensities of each corresponding peak of, NN, NT TN, and TT, respectively. DR was calculated from Lₙ ET and Lₙ EN values of the ET and EN units.

When the DR value is close to 1, the MSD is random, whereas the DR values of a block copolymer and alternating copolymer were 0 and 2, respectively (Zhu et al., “Synthesis, Characterization and Degradation of Novel Biodegradable Poly (Butylene-co-Hexamethylene Carbonate) Copolycarbonates,” Journal of Macromolecular Science, Part A 48:583-594 (2011); Japu et al., “d-Glucose-Derived PET Copolyesters with Enhanced T g,” Polymer Chemistry 4:3524-3536 (2013); Han et al., “Synthesis, Properties of Biodegradable Poly (Butylene succinate-co-Butylene 2-Methylsuccinate) and Application for Sustainable Release,” Materials 12:1507 (2019), which are hereby incorporated by reference in their entirety). ¹H NMR spectra of the 27PEN copolymers and peak assignments appear in FIGS. 3-4; the molar composition of corresponding ethylene terephthalate (ET) and ethylene naphthalate (EN) repeating units in 27PEN copolymers were estimated from these data. For the ¹H NMR spectrum of 27PEN20, chemical shifts of the peak a (δ=8.14 ppm) corresponds to the protons (—CH) of the single aromatic ring, whereas the peak c (δ=8.77 ppm), peak d (δ=8.16 ppm), and peak e (δ=7.94 ppm) represent protons (—CH) of the naphthalene ring. All 27PEN copolymers showed the expected peak area which was close to the feed content of TPA and 2,7-N. The multiple peaks at 4.75-4.95 ppm were assigned to the methylene units (—CH₂—) within the ET and EN repeat units. In particular, three methylene peaks in the 27PEN20 spectrum were attributed to the four possible dyads (NN, NT TN, TT), which can be used to estimate DR. The calculated DR values of 27PEN copolymers were close to 1, which indicated the ET and EN repeating units were randomly distributed in the copolymers.

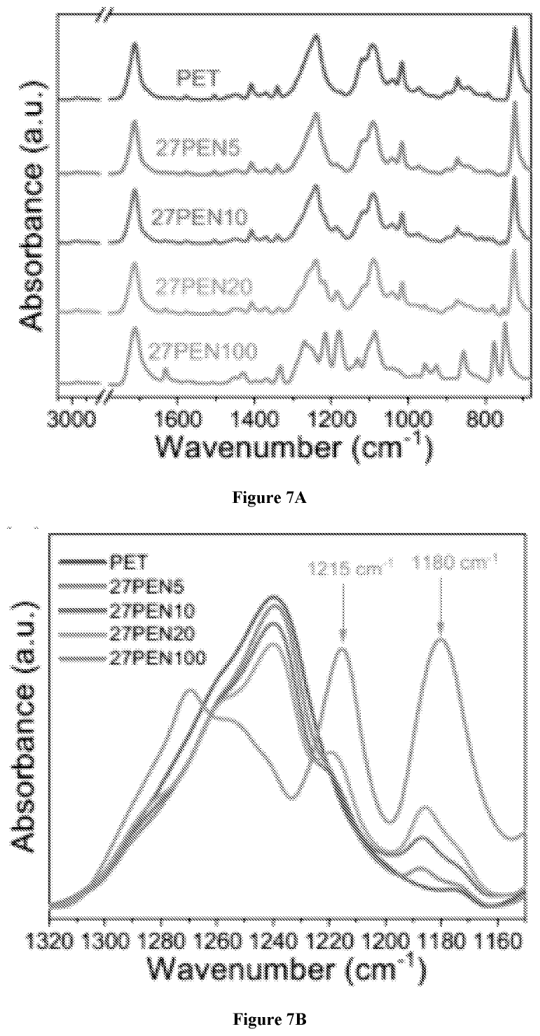

The FTIR spectra of PET and naphthalate-based copolymers are shown in FIGS. 7A-B. The strong peak at 1713 cm⁻¹ was attributed to the stretching vibration of the carbonyl group (C═O) for both PET and 27PEN. The carbonyl (C—O) stretching vibration of PET appeared near 1240 cm⁻¹, while that of 27PEN shifted to 1260 cm⁻¹. In particular, the peak intensity of the naphthalene ring vibration was observed at 1215 and 1180 cm⁻¹ for 27PEN and the copolymers. The increase in the peak intensity of these two peaks was in accordance with the increase in the molar content of 27PEN, and there was no significant peak showing in this region for PET.

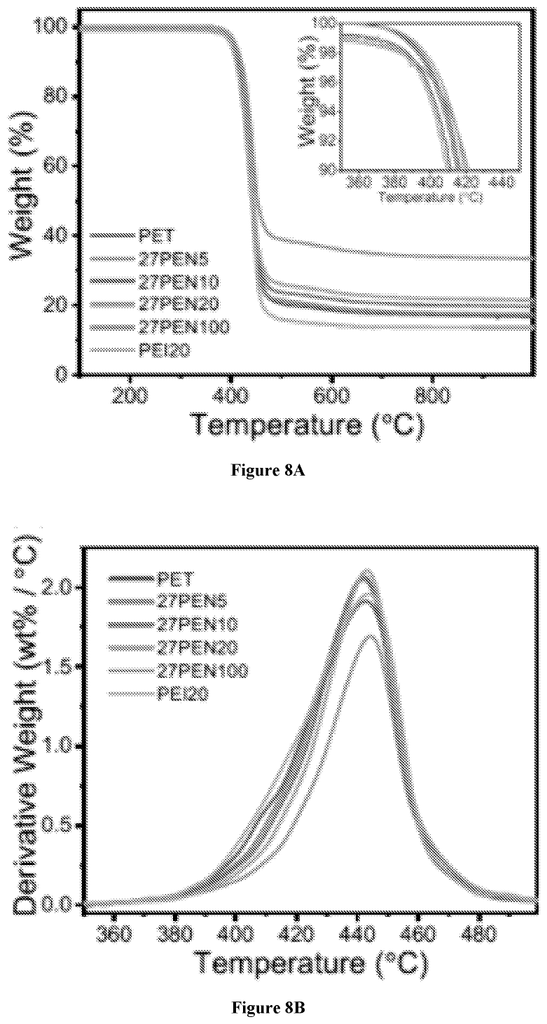

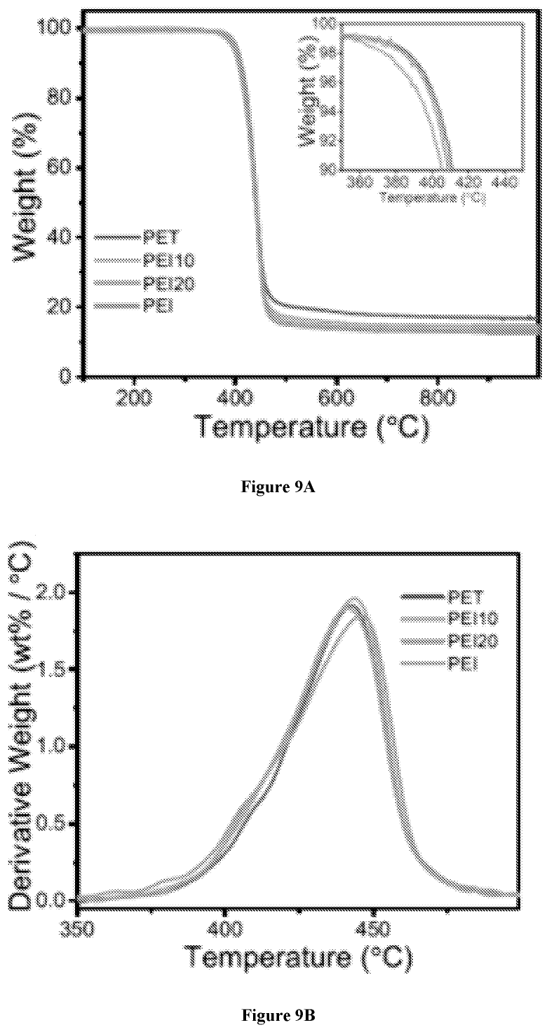

Having established the quantitative and uniform distribution of 2,7-N units in the copolymers, the thermomechanical properties were next examined as a function of composition. As a first consideration, thermal stability has to be understood (FIGS. 8A-B and Table 3). The TGA results indicated that the thermal stability of 27PEN copolymers rose gradually with increasing 2,7-N loading in the materials, which produced slightly more char residue and showed slightly higher T_{d,max} and T_{d,5%} values. In contrast, the thermal stability of PEI copolymers showed an opposite trend of T_{d,max} and T_{d,5%} (FIGS. 9A-B) indicating that the thermal stability of the meta-substitution polymer (PEI) was lower than that of para-substitution polymer (PET). Therefore, the enhancement of the thermal stability was attributed to the fused aromatic rings instead of the meta-substitution orientation. Unsurprisingly, the higher % mass fraction of aromatic content in the polymer chains, the more stable the polymer will be and the higher the char residue will produce.

TABLE 3
Thermal Transition Properties of PET and Naphthalate-Based Copolymers

| | | | | | | | TGA | | |
|---|---|---|---|---|---|---|---|---|---|
| Sample | DSC | | | | | WAXS | | | Residue |
| Code^{a} | T_{g}^{b} | T_{cc}^{b} | T_{c}^{b} | Tₘ^{b} | X_{c} (%)^{b} | X_{c} (%)^{c} | T_{d,5%}^{d} | T_{d,max}^{d} | (wt %)^{d} |
| PET | 69.7 | 124.3 | 179.7 | 237.8 | 33.0 | 56.5 | 401.4 | 442.7 | 16.7 |
| 27PEN5 | 75.4 | 138.7 | 193.3 | 243.2 | 25.3 | 55.6 | 405.1 | 443.1 | 17.4 |
| 27PEN10 | 82.3 | 146.6 | 181.3 | 228.2 | 21.6 | 47.5 | 406.8 | 443.2 | 19.6 |
| 27PEN20 | 90.1 | 163.1 | 139.3 | 207.1 | 3.2 | 35.0 | 409.4 | 443.5 | 21.3 |
| 27PEN100 | 120.1 | N.D. | N.D.^{e} | 341.0 | N.A.^{f} | 18.3 | 407.3 | 444.3 | 33.4 |

^{a}Sample code: 27PENX, x = mol % of 2,7-N repeat unit. ^{b}Glass transition (T_{g}), crystallization (T_{c}), cold crystallization (T_{cc}) and melting (Tₘ) temperatures, degree of crystallinity (X_{c}) during heating cycle. ^{c}Degree of crystallinity (X_{c}) after annealing at 175° C. for 6 hours. ^{d}T_{d.5%}: decomposition temperatures at which the weight loss reached 5% of its initial weight. T_{d,max}: the temperature at the maximum rate of decomposition. The residual mass at 1000° C. ^{e}Not detected by DSC. ^{f}Not available.

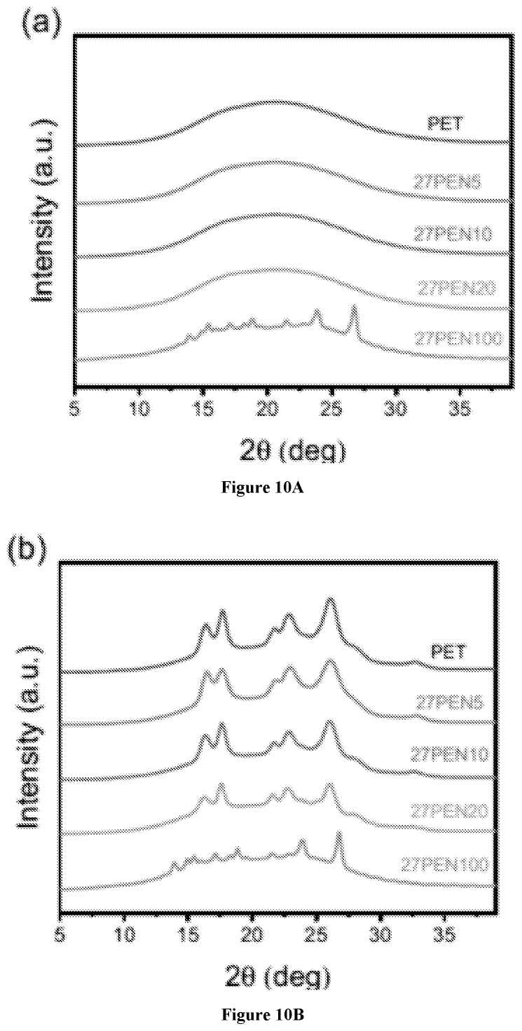

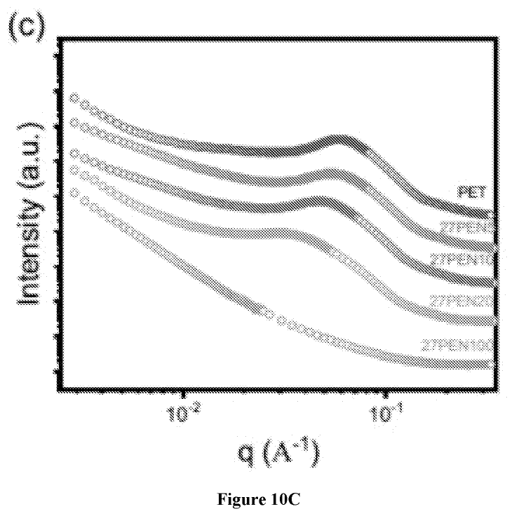

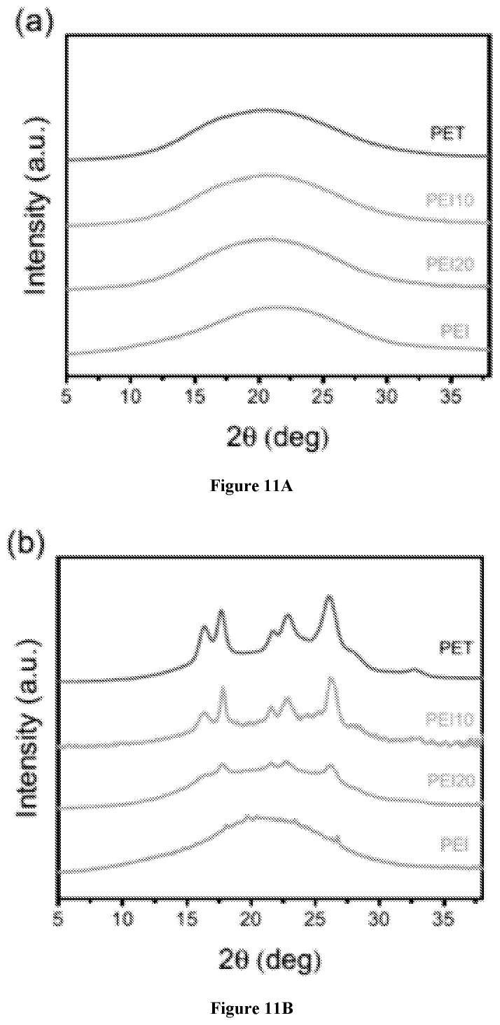

Since the thermal and mechanical properties were significantly dependent on the level of crystallinity and crystallization rate, DSC and WAXS were used to evaluate the effects of 2,7-N loading on the crystallization behaviors (Deshpande et al., “Isothermal Crystallization Kinetics of Anhydrous Sodium Acetate Nucleated Poly (Ethylene Terephthalate),” Journal of Applied Polymer Science 116:3541-3554 (2010); Xing et al., “Poly (Styrene-Co-Maleic Anhydride) Ionomers as Nucleating Agent on the Crystallization Behavior of Poly (Ethylene Terephthalate),” Journal of Applied Polymer Science 132: 41240 (2015); Liu et al., “Miscibility and Crystallization Behavior of Poly (Ethylene Terephthalate)/Phosphate Glass Hybrids,” Journal of Macromolecular Science, Part B 55:1039-1050 (2016); Kim et al., “Unexpected Effects of Inorganic Phosphate Glass on Crystallization and Thermo-Rheological Behavior of Polyethylene Terephthalate,” Polymer 154:135-147 (2018), which are hereby incorporated by reference in their entirety). The WAXS/SAXS patterns of 27PEN copolymers is illustrated in FIGS. 10A-C and the information of crystallinity is summarized in Table 4. The samples before annealing were highly amorphous, showing no WAXS diffraction peaks except 27PEN100, which has been discussed in Lee et al., “Next-Generation High-Performance Bio-Based Naphthalate Polymers Derived from Malic Acid for Sustainable Food Packaging,” ACS Sustainable Chemistry & Engineering 10:2624-2633 (2022), which is hereby incorporated by reference in its entirety. After annealing, the 27PENX diffraction peaks matched those of PET homopolymer, indicating that 27PENX crystals were comprised solely of PET sequences. At modest substitution rates, sequences containing 2,7-N units were too irregular to crystallize and were relegated to the amorphous phase. Furthermore, the degree of crystallinity of the copolymers decreased gradually as the content of 2,7-N increased. In the case of 27PEN copolymers, 2,7-N acted as an impurity from the viewpoint of crystallization, which disrupted the orderly fold pattern of the crystal. A similar trend was observed in PEI copolymer (FIGS. 11A-B). The rising content of IPA in the polymer chains clarified the detrimental effect of crystallization behavior by the comonomer units.

TABLE 4
Crystallinity Values of PET and Naphthalate-Based
Copolymers After Annealing at 175° C. for 6 hours

| Sample | WAXS & SAXS | | | | |
|---|---|---|---|---|---|
| Code^{a} | X_{c} (%)^{b} | qₘₐₓ (Å) | L (Å)^{c} | l_{c} (Å)^{d} | lₐ (Å)^{e} |
| PET | 56.5 | 0.058 | 108.3 | 61.2 | 47.1 |
| 27PEN5 | 52.5 | 0.053 | 118.6 | 62.3 | 56.3 |
| 27PEN10 | 47.5 | 0.047 | 133.7 | 63.5 | 70.2 |
| 27PEN20 | 35.0 | 0.029 | 216.7 | 75.8 | 140.9 |
| 27PEN100 | 18.3 | — | — | — | — |

^{a}Sample Code: 27PENX, x = mol % of 2,7-N unit.
^{b}Degree of crystallinity calculated from the WAXSpattern.
^{c}Lamellar thickness.
^{d}Crystal lamellar thickness.
^{e}Amorphous lamellar thickness.

The effect of 2,7-N in PET chains on the lamellar periodicity of the copolymers was studied using SAXS (FIGS. 10A-C and Table 4). The SAXS patterns exhibited a clear peak due to the periodic lamellar stacks, and the lamellar thickness correlated with peak position. The peak position varied monotonically as a function of 2,7-N content, as it tended to decrease as the content of fused aromatic rings increased. This implied that the long period (L, Table 4) increased along with 2,7-N loading (Hong et al., “High Molecular Weight Bio Furan-Based Copolyesters for Food Packaging Applications: Synthesis, Characterization and Solid-State Polymerization,” Green Chemistry 18:5142-5150 (2016); Flores et al., “PET-ran-PLA Partially Degradable Random Copolymers Prepared by Organocatalysis: Effect of Poly (1-lactic Acid) Incorporation on Crystallization and Morphology,” ACS Sustainable Chemistry & Engineering 7:8647-8659 (2019), which are hereby incorporated by reference in their entirety). The amorphous lamellar thickness (lₐ) (Equation 8) also increased along with 2,7-N loading, which lead to the reduction of overall crystallinity in 27PEN copolymers and was in line with the WAXS results. However, the crystal lamellar thickness (l_{c}) (Equation 5) showed an increasing trend along with 2,7-N loading as well, which contradicted the comonomer unit exclusion hypothesis. Hence, an alternative explanation was required. Based on the model proposed by previous studies, a one-dimensional correlation function, including long period (L) as well as the crystal/amorphous lamellar thickness, can be obtained by using the inverse-cosine-Fourier-transform of the SAXS profile (Strobl et al., “Model of Partial Crystallization and Melting Derived from Small-Angle X-Ray Scattering and Electron Microscopic Studies on Low-Density Polyethylene,” Journal of Polymer Science: Polymer Physics Edition 18:1361-1381 (1980); Goderis et al., “Use of SAXS and Linear Correlation Functions for the Determination of the Crystallinity and Morphology of Semi-Crystalline Polymers. Application to Linear Polyethylene,” Journal of Polymer Science Part B: Polymer Physics 37:1715-1738 (1999), which are hereby incorporated by reference in their entirety). The results implied that the crystal/amorphous lamellar thickness needed to be estimated correctly with the relative volume fraction of lamellae rather than with the bulk volume crystallinity. The results in these studies showed that l_{c} decreases as the comonomer loading increases, in accord with the comonomer exclusion hypothesis.

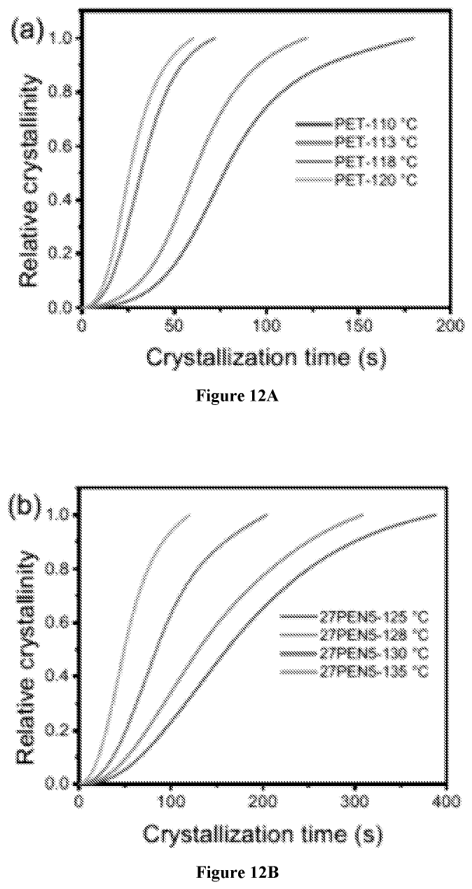

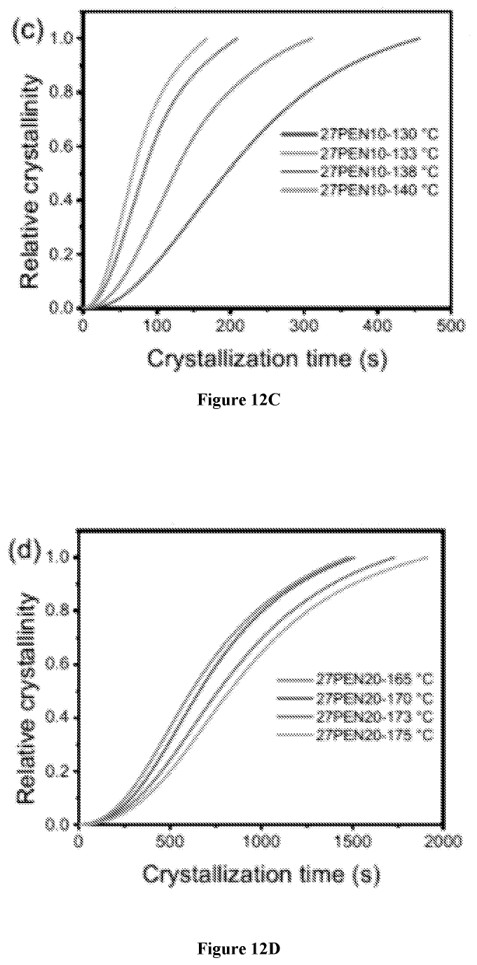

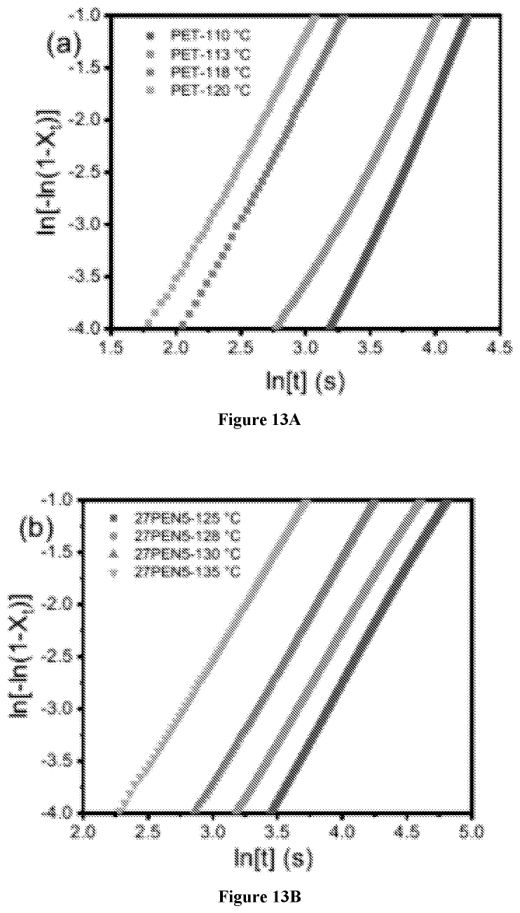

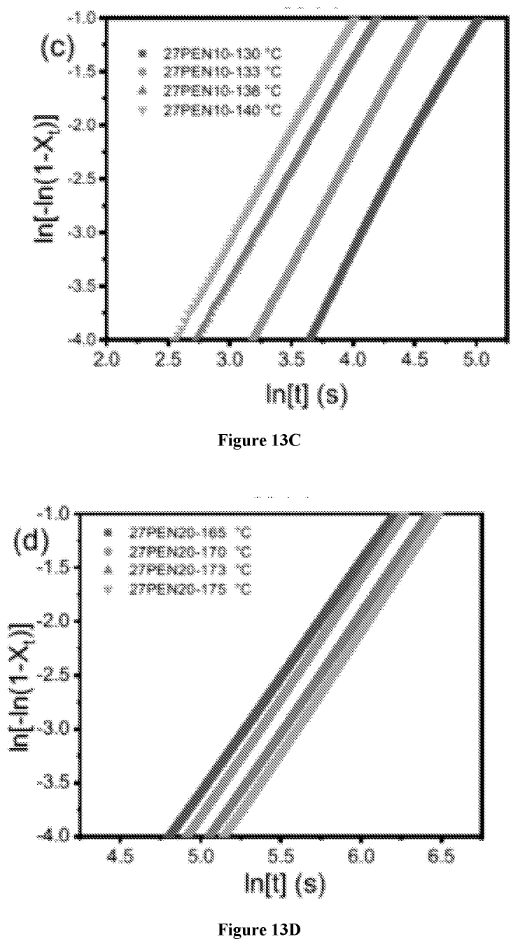

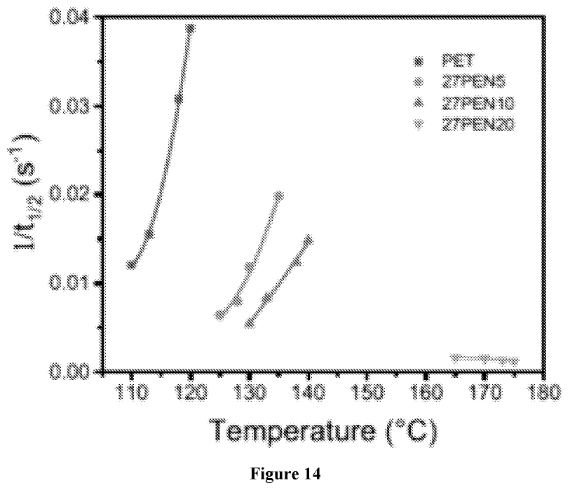

The impact of 2,7-N on crystallization dynamics was also investigated through a series of isothermal DSC experiments (FIGS. 12A-D and 13A-D). Following Avrami kinetics, the crystallized fraction versus time followed a sigmoidal curve. The crystallization rate constant (k) increased with temperature and decreased with 2,7-N loading. The increase with temperature was due to accelerated chain mobility. The downward trend was due to the crystal disruption by 2,7-N and the higher energy requirement for chain rearrangement, which was in accordance with the WAXS results. The reciprocal crystallization half-time (t_{1/2}⁻¹) versus temperature was more intuitive to describe the dependence of overall crystallization rate vs. temperature (FIG. 14). The t_{1/2} values of 27PEN copolymers except 27PEN20 increased with temperature (faster crystallization), whereas 27PEN20 showed a downward trend. This observation can be understood through consideration of two competing factors: first, crystal nuclei are easier to form as the crystallization temperature decreases, which leads to crystallization rate acceleration. Second, the polymer chain diffusion slows down as T approaches T_{g}. Therefore, the crystallization rate increases as temperature is reduced when near Tₘ due to the increased thermodynamic driving force, but passes through a maximum rate due to attenuation of the chain mobility (Lu et al., “Isothermal Crystallization Kinetics and Melting Behaviour of Poly (Ethylene Terephthalate),” Polymer 42:9423-9431 (2001), which is hereby incorporated by reference in its entirety). The temperature conditions of PET and 27PEN copolymers except 27PEN20 were dominated by the second term, whereas that of 27PEN20 was dominant by the first term.

The mechanism of nucleation and the morphology of crystal growth is suggested by the Avrami exponent n, which varies from 0.5 to 4 for most semicrystalline polymers (Hiemenz et al., Polymer Chemistry (2007), which is hereby incorporated by reference in its entirety). As shown in Table 5, an average value of n=2.5 for PET was obtained. Since PET is a pure homopolymer without any nucleating agent, the nucleation mechanism is a homogeneous nucleation followed by three-dimensional spherulite growth, in accordance with Avrami exponent value. In contrast, the values for the copolymers were close to 2.1. This implied that 2,7-N units might act as nucleating agents, since nucleation is often very sensitive to “impurities” in the system. Therefore, the crystal geometry growth of 27PEN copolymers shifted to two-dimensional axialites. As 2,7-N loading in the copolymers increased further, the development of three-dimensional order became more difficult and will be replaced by two-dimension axialite. Nonetheless, since there were many other factors that would affect the nucleation of the polymer such as the free energy changes on crystallization, the lamellar thickness, and the interfacial energy, etc, further study was required to understand the nucleation mechanism of 27PEN copolymers in future works.

TABLE 5
Parameters of Isothermal Crystallization
Calculated by Avrami Equation

| Sample Code | T_{c}^{a} (° C.) | n^{a} | k^{a} | t_{1/2}^{a} (s) |
|---|---|---|---|---|
| PET | 110 | 2.67 | 5.236*10−6 | 82.9 |
| | 113 | 2.51 | 1.988*10−5 | 64.5 |
| | 118 | 2.42 | 1.522*10−4 | 32.5 |
| | 120 | 2.40 | 2.850*10−4 | 25.8 |
| 27PEN5 | 125 | 2.23 | 8.994*10−6 | 155.4 |
| | 128 | 2.14 | 2.219*10−5 | 126.0 |
| | 130 | 2.21 | 3.800*10−5 | 84.7 |
| | 135 | 2.1 | 1.844*10−4 | 50.4 |
| 27PEN10 | 130 | 2.21 | 6.777*10−6 | 184.9 |
| | 133 | 2.19 | 1.944*10−5 | 119.8 |
| | 138 | 2.09 | 7.124*10−5 | 80.9 |
| | 140 | 2.08 | 1.091*10−4 | 67.4 |
| 27PEN20 | 165 | 2.16 | 6.680*10−7 | 609.8 |
| | 170 | 2.24 | 3.404*10−7 | 655.3 |
| | 173 | 2.23 | 2.689*10−7 | 749.9 |
| | 175 | 2.28 | 1.584*10−7 | 817.9 |

^{a}T_{c}: the isothermal crystallization temperature,
k: the crystallization rate constant,
n: the Avrami exponent,
t_{1/2}: thecrystallization half-time

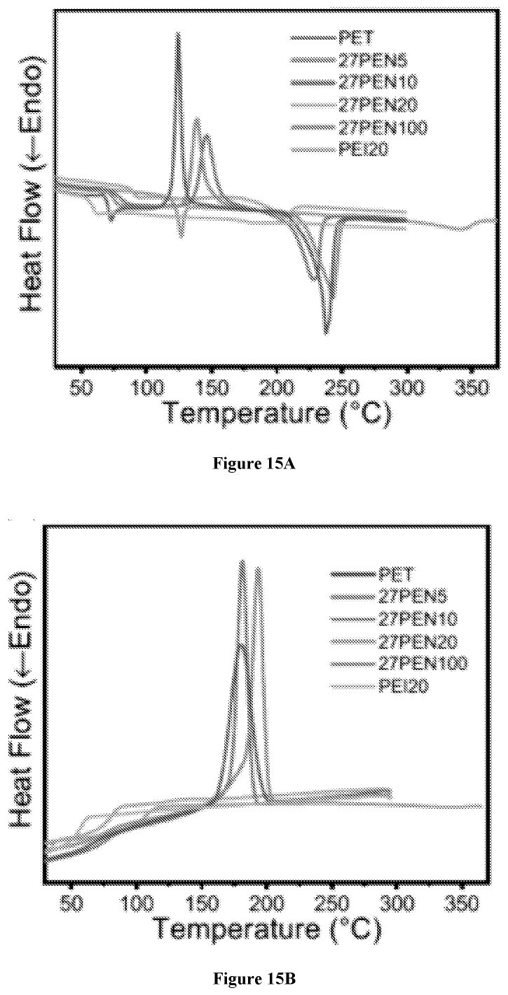

The melting point Tₘ (FIGS. 15A-B and Table 3) passed through a maximum in 27PEN5 and decreased thereafter, illustrating the interplay of competing enthalpic and entropic effects. At sparing 2,7-N composition, the extent of crystallinity was not yet significantly impacted; from the perspective of a crystalline PET sequence, the enthalpic penalty for melting was increased due to the thermodynamically incompatible 2,7-N units in the amorphous phase. However, at a higher 2,7-N fraction, the lamellar thickness was suppressed due to shorter PET sequences. This increased the crystallite surface area (and surface energy), depressing the melting point as anticipated by the Thompson-Gibbs equation (Hiemenz et al., Polymer Chemistry (2007), which is hereby incorporated by reference in its entirety).

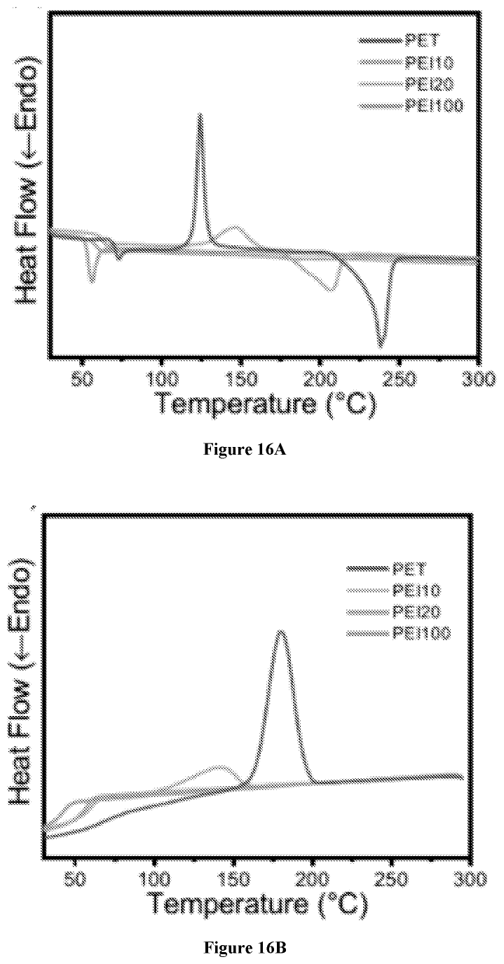

Likewise, the melt recrystallization temperature T_{c} also passed through a maximum with respect to 2,7-N loading. Based on the Avrami analysis above, the comonomer unit (2,7-N) might act as a nucleation site. This tends to increase T_{c} as observed in 27PEN5. As the 2,7-N composition increased, however, its disruption to the regularity of crystallizable PET sequences overwhelmed the nucleation effect and depressed T_{c}. In the case of cold crystallization, the T_{cc} trend increased along with 2,7-N loading. This could be attributed to the energy barriers for the chain motion increase with the increasing amount of fused aromatic rings, requiring greater thermal energy for chain rearrangement. A similar trend was observed in thermal behaviors of PEI copolymers (FIGS. 16A-B and Table 6), which further demonstrated that both the comonomer units (2,7-N and IPA) can cause the disruption effect on PET crystallization ability.

TABLE 6
Thermal Transition Properties of PET and Isophthalate-Based Copolymers

| Sample | DSC | | | | | TGA | | |
|---|---|---|---|---|---|---|---|---|
| Code^{a} | T_{g}^{b} | T_{cc} ^{b} | T_{c}^{b} | Tₘ^{b} | X_{c} (%)^{b} | T_{d,5%}^{c} | T_{d.max}^{c} | Residue (wt %)^{c} |
| PET | 69.7 | 124.3 | 179.7 | 237.8 | 33.0 | 401.4 | 442.7 | 16.7 |
| PEI10 | 62.2 | 147.0 | 141.6 | 207.1 | 18.9 | 399.5 | 441.3 | 14.4 |
| PEI20 | 58.0 | 157.0 | N.D.^{d} | 182.9 | 0.6 | 399.3 | 443.6 | 13.5 |
| PEI100 | 51.3 | N.D. | N.D | N.D. | N.D. | 393.3 | 445.9 | 12.5 |

^{a}Sample code: PEIX , x = mol % of IPA repeat unit. ^{b}Glass transition (T_{g}), crystallization (T_{c}), cold crystallization (T_{cc}), and melting (Tₘ) temperatures, degree of crystallinity (X_{c}) during heating cycle. ^{c}T_{d,5%}: decomposition temperatures at which the weight loss reached 5% of its initial weight. T_{d,max}: the temperature at the maximum rate of decomposition. The residual mass at 1000° C. ^{d}Not detected by DSC.

In summary, the dramatic difference in the thermal properties shown between 27PEN20 and other composition copolymers can be attributed to the disruption effect of the comonomer on PET crystallization ability. When 2,7-N loading is below 10%, the crystallization ability was not yet significantly affected. However, the crystallization ability of 27PEN20 was close to the boundary that crystal formation will become critically hindered and cause the polymer to be completely amorphous. This observation was in agreement with a study exploring custom property enhancements for polyamides by bioenabled platform monomers (Carter et al., “Bioenabled Platform to Access Polyamides with Built-In Target Properties,” Journal of the American Chemical Society 22:6444-6454 (2020), which is hereby incorporated by reference in its entirety).

Turning to the amorphous phase, where the vast majority of the 2,7-N content evidently resides, all 27PEN copolymers showed one unique T_{g} value via DSC, indicating a homogeneous amorphous phase. T_{g} increased with 2,7-N content. 27PEN20 showed a T_{g} value more than 20° C. higher compared to PET, reaching T_{g}=120° C. for 27PEN100. Comparison with PEI analogs showed this effect was attributed to the increased chain stiffness from the fused aromatic rings and not the meta-substitution pattern. PEI20 has a T_{g} about 10° C. lower than PET, dropping to 51.3° C. for PEI 100 homopolymer (FIGS. 16A-B, Table 6). In conclusion, the thermal and crystallization behaviors of 27PEN copolymers can be tuned by adjusting 2,7-N content to meet the desired performance for specific application.

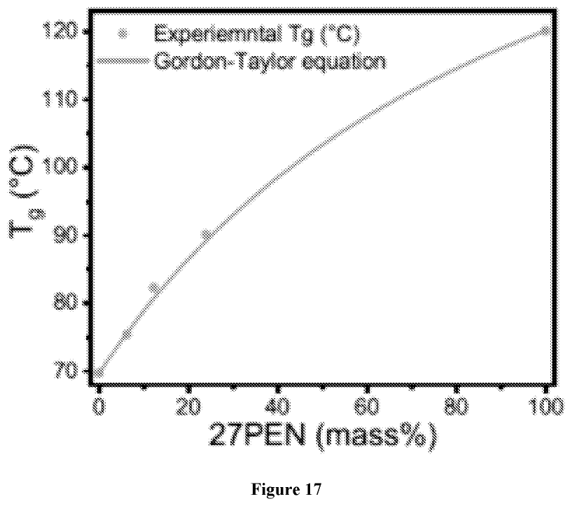

In addition, to reach the target of saving cost and time as well as to predict the performance of the materials, using a model before doing experiment would be cost-effective and time-saving. The trend of T_{g} versus 27PEN loading shows a monotonic dependency, which can be fitted to semiempirical equation, Gordon-Taylor equation (equation 12) (FIG. 17). The higher 2,7-N loading copolymer can be estimated by using the following equation:

$${T}_{g} {,}_{27 PENcopolymer} = \frac{{k}_{GT} {w}_{1} {T}_{g , 1} + ( 1 - {w}_{1} ) {T}_{g , 2}}{{k}_{G T} {w}_{1} + ( 1 - {w}_{1} )} \qquad ( Eq . 12 )$$

where T_{g,1} and T_{g,2} are the glass transition temperature of 27PEN and PET homopolymer, respectively. w₁ corresponds to the weight fraction of the 27PEN units in the copolymer; and k_{GT} is the Gordon-Taylor parameter, which is an adjustable fitting parameter. A highly correlated fitting was obtained with k_{GT}=2, indicating a behavior that was typical of random copolymers.

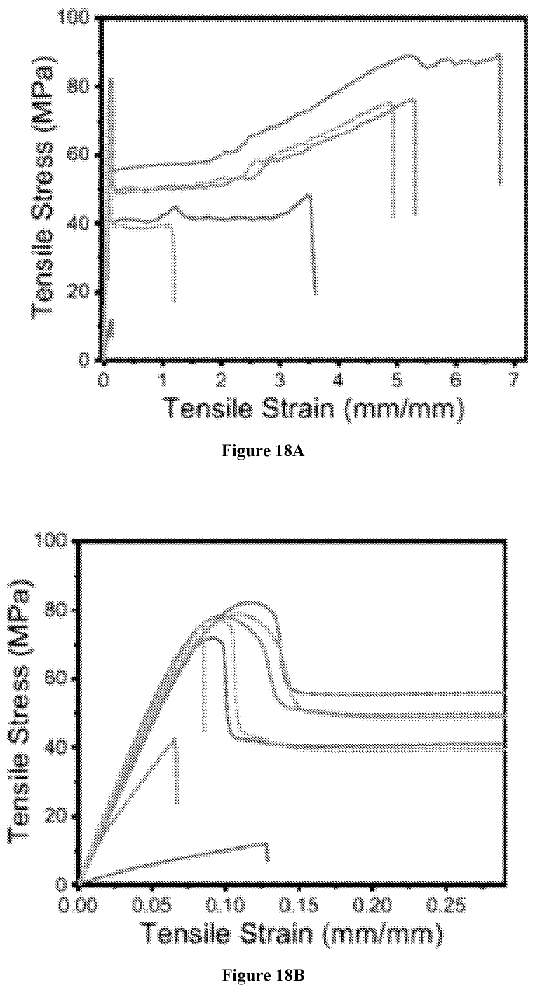

Measuring and understanding the mechanical properties is critical for processing control as well as product development (Khosravi-Darani et al., “Application of Poly (Hydroxyalkanoate) in Food Packaging: Improvements by Nanotechnology,” Chemical and Biochemical Engineering Quarterly 29:275-285 (2015), which is hereby incorporated by reference in its entirety). Therefore, tensile testing was used to assess the effect of 2,7-N loading in the mechanical aspect of the copolymer (FIGS. 18A-B). The mechanical properties, especially elongation at break, can be affected by the extent of crystallinity inside PET. A small amount of crystal embedded inside the sample might result in the fracture before reaching maximum elongation at break. In order to measure the true flexibility of the materials, completely amorphous tensile samples of PET and 27PEN copolymers were prepared via injection molding at 270° C. into a 40° C. mold, which was confirmed by WAXS. As shown in Table 7, 27PEN100 showed brittle performance compared to PET, which has been discussed in Lee et al., “Next-Generation High-Performance Bio-Based Naphthalate Polymers Derived from Malic Acid for Sustainable Food Packaging,” ACS Sustainable Chemistry & Engineering 10:2624-2633 (2022), which is hereby incorporated by reference in its entirety. However, the copolymers showed ductile deformation with similar yield, plastic deformation, and necking behaviors as compared to PET. Notably, PET fractured after necking with only slight strain hardening, whereas 27PEN copolymers displayed obvious strain hardening before breaking. Strain hardening was observed as a strengthening of a material during large strain deformation, which was attributed to the fact that the polymer chains tend to orient and align in the direction of the load and results in the crystallization of lamellar crystals perpendicular to the strain axis. The tensile strength of strain hardening showed an increase of almost 200% from 40 MPa to 80 MPa as 2,7-N loading increases to 10%, and was followed by a decrease to 70 MPa with 20% loading thereafter. This observation can be attributed to two effects: first, the increase in the rigidity of the polymer chains due to the fused aromatic rings segment, which enables the materials to withstand higher load without being damaged. Second, the suppression effect of 2,7-N will disrupt the strain-induced crystallization, which was affirmed by the WAXS, SAXS, and DSC results. At low loading (<10%) of 2,7-N, the first term was predominant while the crystallization ability is still sufficiently high. As 2,7-N loading keeps increasing, the crystallization ability of the copolymer was dramatically affected and overwhelms the first term eventually. Based on the same effects mentioned above, a similar trend was also shown in elongation at break. The elongation at break showed an increase of 70% more than that of PET as 2,7-N loading increased to 10%; however, as 2,7-N loading kept rising up to 20%, it only showed an improvement of 40% increase compared to that of PET. All the observations were in agreement with the results of PEI copolymer reported in Karayannidis et al., “Thermal Behavior and Tensile Properties of Poly (Ethylene Terephthalate-co-Ethylene Isophthalate),” Journal of Applied Polymer Science 78:200-207 (2000), which is hereby incorporated by reference in its entirety, as well as the experimental results described in the present application.

TABLE 7
Mechanical and Barrier Properties of the Homo- and Copolymers

| | Young's | Yield | | Impact | O₂ |
|---|---|---|---|---|---|
| Sample | modulus | Strength | Elongation | Strength | permeability |
| Code^{a} | (Mpa) | (Mpa) | at break (%) | (J/m) | (Barrer)^{b} |
| PET | 1026.8 ± | 73.0 ± | 359.4 ± | 12.6 ± | 0.0108 |
| | 23.9 | 2.4 | 20.1 | 1.8 | |
| 27PEN5 | 1028 ± | 76.1 ± | 503.9 ± | 13.7 ± | 0.0099 |
| | 45.5 | 2.4 | 46.2 | 0.6 | |
| 27PEN10 | 991.1 ± | 82.9 ± | 611.9 ± | 14.1 ± | 0.0095 |
| | 20.5 | 5.6 | 74.1 | 1.8 | |
| 27PEN20 | 987.3 ± | 77.1 ± | 494.7 ± | 13.1 ± | 0.0073 |
| | 19.0 | 1.5 | 27.8 | 0.6 | |
| 27PEN100 | 756.7 ± | 44.9 ± | 6.5 ± | 12.5 ± | 0.0022 |
| | 76.9 | 13.0 | 1.8 | 1.2 | |
| PEI10 | 1049.7 ± | 78.2 ± | 98.7 ± | 12.4 ± | N.A.^{c} |
| | 12.2 | 2.2 | 18.9 | 0.4 | |
| PEI20 | 1162.3 ± | 78.0 ± | 9.1 ± | 11.9 ± | N.A. |
| | 95.2 | 3.8 | 2.0 | 0.7 | |
| PEI100 | 144.8 ± | 12.3 ± | 14.3 ± | 9.1 ± | N.A. |
| | 30.7 | 0.4 | 2.7 | 0.3 | |

^{a}Sample code: 27PENX/PEIX, x = mol % of 2,7-N/IPA repeat unit.
^{b}1 Barrer = 3.348*10⁻¹⁶ mol m m⁻² s⁻¹ Pa⁻¹.
^{c}Not available.

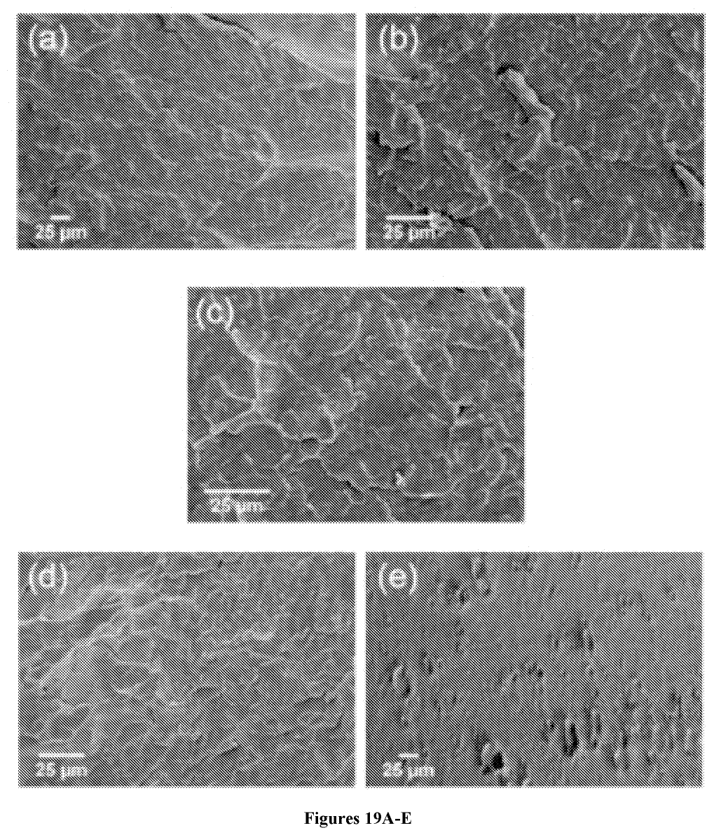

SEM images of fractured polymer were further analyzed with the aim of providing a direct observation on the material appearance and elucidating the differences in mechanical properties (FIGS. 19A-E). PET and 27PENX copolymers exhibited a massive network of cracks across the specimen surface, indicating the ability of these materials to dissipate energy throughout the sample. In contrast, 27PEN100 showed a smooth surface with tiny crystals, which has been discussed Lee et al., “Next-Generation High-Performance Bio-Based Naphthalate Polymers Derived from Malic Acid for Sustainable Food Packaging,” ACS Sustainable Chemistry & Engineering 10:2624-2633 (2022), which is hereby incorporated by reference in its entirety. Analysis of surface appearance confirmed that 27PENX copolymers possessed similar energy dissipating ability to that of PET.

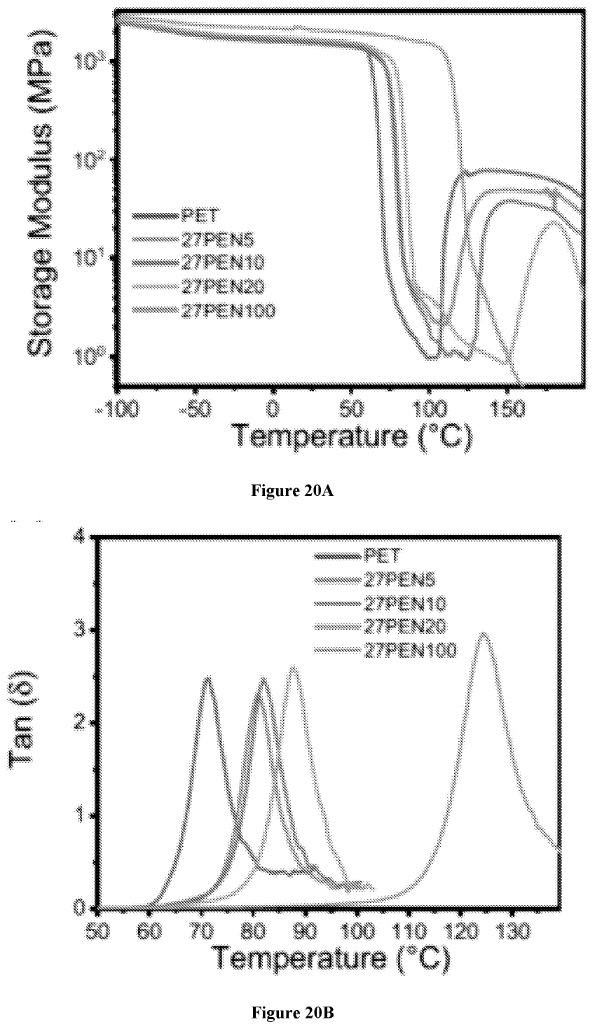

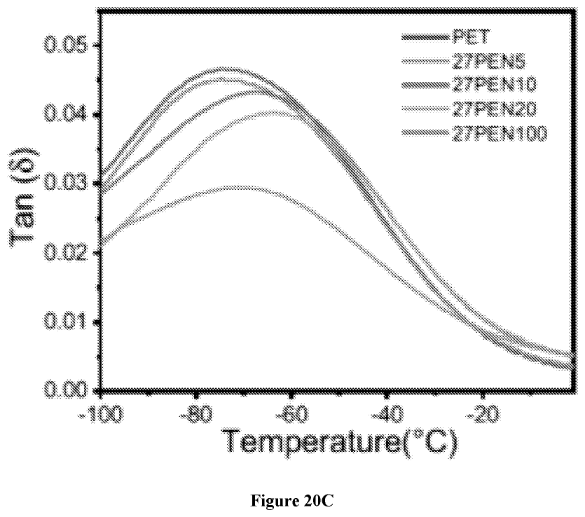

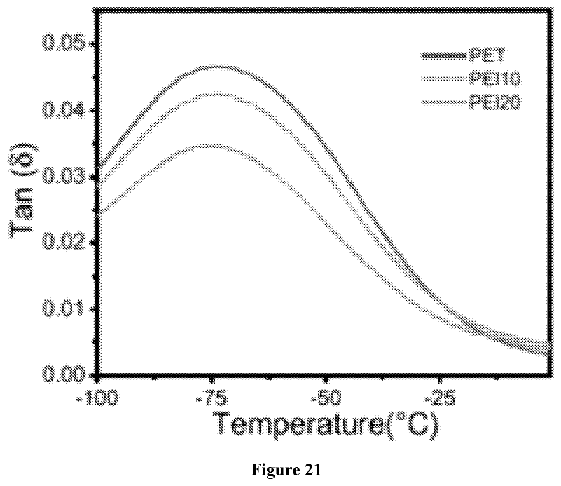

In addition to thermal, crystallization, and mechanical aspects, barrier performance is also critical for making useful single-use packaging equipment. To that end, the effect of PET modification by 2,7-N on the barrier properties must be studied to meet Food and Drug Administration requirements for food packaging. Herein, the γ-relaxation could be expressed by a change in activation energy for either diffusion or permeation which relates to barrier properties; thus, DMA was performed to investigate low-temperature molecular motions of 27PEN copolymers (FIG. 20C) (Boyer, R., “Dependence of Mechanical Properties on Molecular Motion in Polymers,” Polymer Engineering & Science 8:161-185 (1968); Robeson et al., “Secondary Loss Transitions in Antiplasticized Polymers,” Journal of Polymer Science Part B: Polymer Letters 7:35-40 (1969); Light et al., “Effect of Sub-Tg Relaxations on the Gas Transport Properties of Polyesters,” Polymer Engineering & Science 22:857-864 (1982); Burgess et al., “Chain Mobility, Thermal, and Mechanical Properties of Poly (Ethylene Furanoate) Compared to Poly (Ethylene Terephthalate),” Macromolecules 47:1383-1391 (2014), which are hereby incorporated by reference in their entirety). As 2,7-N loading in the polymer chain increased, Ty transition increased from −74.2 to −63.4° C., indicating that more energy was needed for the copolymer to carry out localized chain motion. Furthermore, it appeared that the observed reduction in γ-relaxation peak areas was entirely the result of modifying PET polymer chain with an meta-substitution fused aromatic rings, which restricted sub T_{g} molecular motions. The observation for this change can be separated into two effects: first, the incorporation of the restricted mobility naphthalene ring in the polymer chains, which is in accordance with the trend reported in Polyakova et al., “Oxygen Barrier Properties of Polyethylene Terephthalate Modified with a Small Amount of Aromatic Comonomer,” Journal of Polymer Science Part B: Polymer Physics 39:1900-1910 (2001), which is hereby incorporated by reference in its entirety. Second, the meta-substitution structure decreases the chain mobility compared to the para-substitution structure. A similar trend shown in PEI copolymers (FIG. 21) further illustrated that the meta-structure repeating unit could suppress the ring flip motion of the para-structure polymer.

In addition to the γ-transition, the α-transition and crystallization behaviors of 27PEN copolymers were studied. The peak of α-transition (denoted as Tα in FIG. 20B) increased with the increasing amount of 2,7-N. This was attributed to the inhibition of the free movement of the polymer chain in amorphous phase from the embedded fused aromatic rings segment. The T_{α} value was comparable to the T_{g} determined by DSC, which indicated that the copolymer with higher 2,7-N loading possessed higher service temperature. The subsequent increase in storage modulus (related to the elasticity of the material) (FIG. 20A) α-transition that reached the rubbery plateau was attributed to cold crystallization, which was associated with the density modulation caused by the formation of a crystalline phase (Codou et al., Glass Transition Dynamics and Cooperativity Length of Poly (Ethylene 2,5-Furandicarboxylate) Compared to Poly (Ethylene Terephthalate),” Physical Chemistry Chemical Physics 18:16647-16658 (2016); which is hereby incorporated by reference in its entirety). The starting temperature of cold crystallization increased along with 2,7-N loading in the copolymers, which further proved the interference effect of 2,7-N on crystallization, consistent with the cold crystallization results detected by DSC. The value of storage modulus decreased progressively with 2,7-N loading. It is probable that the reduced crystal packing efficiency afforded by comonomer loading largely depressed the crystal lamellar thickness and caused the elasticity to drop. This phenomenon becomes more pronounced with increased 2,7-N loading, and the rubbery plateau related to cold crystallization will vanish when the crystallization ability is completely destroyed.

These cooperative relaxation phenomena are implicitly related to the gas permeability. The oxygen barrier performance is very important to many performance packaging applications. The oxygen permeability of 27PEN copolymers decreased monotonically with 2,7-N loading (Table 7). The oxygen barrier performance of 27PEN20 (0.0073 barrer) showed a 30% improvement over PET (0.0108 barrer) with only 20% 2,7-N embedded in PET chains, indicating the barrier capability of meta-substitution fused aromatic rings is 2 times better than that of commercial used para-substitution fused aromatic rings (26NDA) reported in Lillwitz, L., “Production of Dimethyl-2,6-Naphthalenedicarboxylate: Precursor to Polyethylene Naphthalate,” Applied Catalysis A: General 221:337-358 (2001), which is hereby incorporated by reference in its entirety. This is mainly attributable to restricted ring-flip associated with the nonlinear axis of meta-naphthalene structure, which would suppress the chain rotation and mobility related directly to gas diffusivity.

In summary, 27PEN copolymers showed improved performance compared to PET with respect to thermal, mechanical, and barrier properties, which strongly suggested that these copolymers with value-added property improvement using biosourced 2,7-N are promising candidate materials for broader packaging applications. Nonetheless, more analysis, including techno-economic and life-cycle assessment and toxicological, of 2,7-N would be necessary before being commercialized in large-scale for food packaging.

In the present application, PET incorporated with bio-derived naphthalate-based monomers were successfully synthesized by a two-step melt polycondensation reaction. ¹H NMR analysis revealed that the synthesized copolymers were statistically random copolymers and the molar ratio of 2,7-N in the copolymers was consistent with that of the input reactants. Comonomer units were found to partition into the amorphous phase while leaving the crystal lattice units unaltered. 2,7-N acted as an impurity from the viewpoint of crystallization, which significantly affected the nucleation mechanism and crystallization ability of the materials. The observed results were the change in crystal geometry from 3D spherulite growth to 2D axialite growth, as well as the increasing suppression effect on crystal lamellar thickness with increasing 2,7-N loading. The effect that 2,7-N imposed on crystallization behaviors was the key to the improvement of thermal and mechanical properties. By analysis using various methods, it was confirmed that 2,7-N had a positive effect on the drawbacks of PET, where 27PEN10 in particular showed a dramatic increase in all the properties while retaining most of the crystallization behaviors of PET. The T_{g} of 27PEN10 was 15° C. higher than that of PET, which was due to the increased energy barrier of the chain motion for the polymer chains in amorphous domain, whereas the increased rigidity of the polymer chain caused by fused aromatic rings resulted in the improvement in strain hardening and elongation at break. Moreover, the restricted ring-flip associated with the nonlinear axis of meta-naphthalene structure effectively suppressed the oxygen permeability of the materials. These results suggest that bioadvantaged comonomers like 2,7-N are capable of being used for modifying polymer properties, both in sustainability and performance compared with those of traditional PET. This strategy would not only allow PET to have widespread applications requiring higher service temperature, and better barrier/mechanical properties, but also constructed the fundamental structure-property relationships connecting the bioadvantaged chemicals as hard-segment inside polymers to its performance. Compared to the petroleum-derived chemicals (IPA, CHDM, DEG) which are widely available and under commercial development including technoeconomic model development, 2,7-N is a potential bio-derived chemical, which could be used in PET property enhancements, and further studies like techno-economic and life-cycle assessment would need to be developed. In general, by utilizing bioadvantaged monomers, the economic incentive for adoption and industry growth of biochemicals can be provided and capital requirements for product startup can be simultaneously minimized.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A polymer comprising a moiety of formula:
wherein 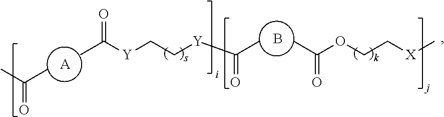 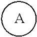
is monocyclic or bicyclic arylene, monocyclic or bicyclic heteroarylene, or monocyclic or bicyclic non-aromatic heterocyclene; 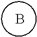
is monocyclic or bicyclic arylene, monocyclic or bicyclic heteroarylene, or monocyclic or bicyclic non-aromatic heterocyclene, wherein monocyclic or bicyclic arylene, monocyclic or bicyclic heteroarylene, or monocyclic or bicyclic non-aromatic heterocyclene can be optionally substituted from 1 to 3 times with R;
X is NH or O;
Y is NH or O;
R is independently selected at each occurrence thereof from the group consisting of H, OH, and —OR′;
R′ is C₁₋₂₀ alkyl, C₂₋₂₀ alkenyl, or C₂₋₂₀ alkynyl;
s is 1 to 21;
k is 1 to 21;
i and j represent number average degrees of polymerization for repeat units of formula I that are distributed throughout the polymer chain in a statistically defined manner;
i is 1 to 1,000,000; and
j is 1 to 1,000,000;
or a salt thereof.

2. The polymer according to claim 1, wherein the polymer has the structure of formula (I): 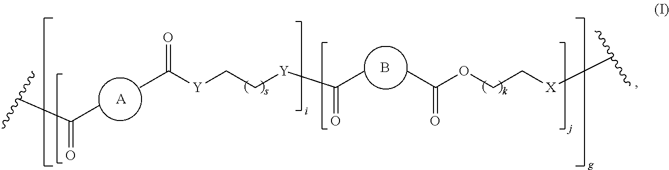
wherein 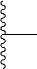
is a terminal group of the polymer;
g is 1 to 1,000;
each i is independently selected from 1 to 1,000,000; and
each j is independently selected from 1 to 1,000,000,
wherein the sum of i, i₂, i₃ . . . i_{g} is 1 to 1,000,000, and the sum of j, j₂, j₃ . . . j_{g} is 1 to 1,000,000.

3. The polymer according to claim 1, wherein 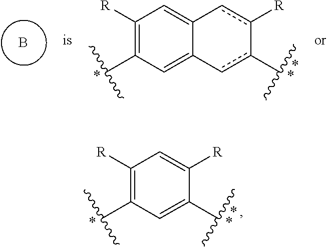 [symbol]
is a single or a double bond, 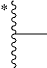
is a point of attachment of 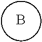
to —C(O) group, and 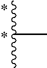
is a point of attachment of 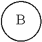
to —C(O)—X— group.

4. The polymer according to claim 2, wherein the polymer has the structure of formula (Iₐ):

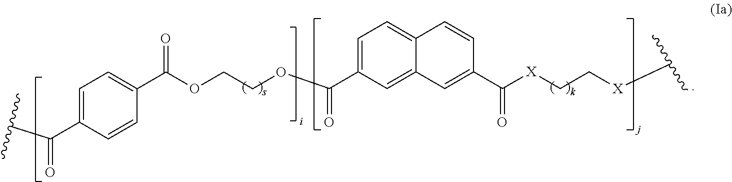

5. The polymer according to claim 2, wherein the polymer has the structure of formula (Ib):

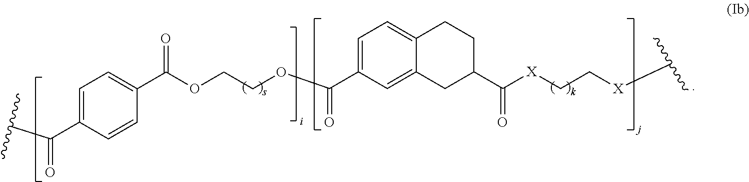

6. The polymer according to claim 2, wherein the polymer has the structure of formula (Ic):

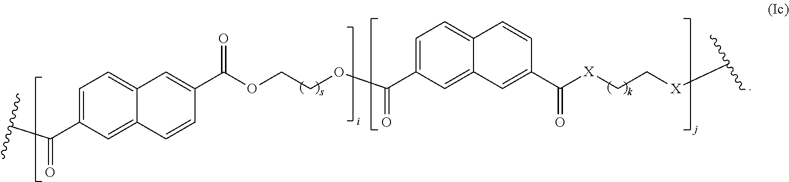

7. The polymer according to claim 2, wherein the polymer has the structure of formula (Id):

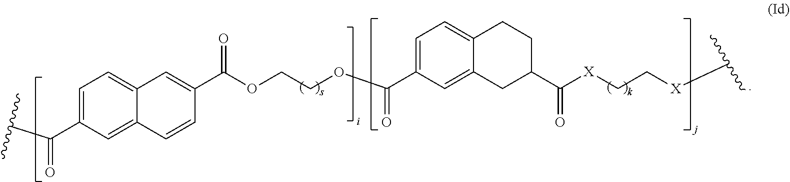

8. The polymer according to claim 2, wherein the polymer has the structure of formula (Ie):

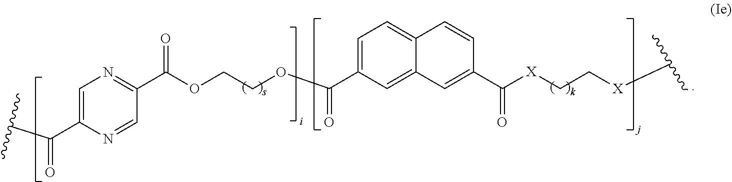

9. The polymer according to claim 2, wherein the polymer has the structure of formula (If):

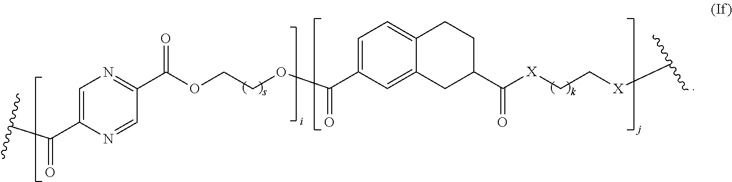

10. The polymer according to claim 2, wherein the polymer has the structure of formula (Ig):

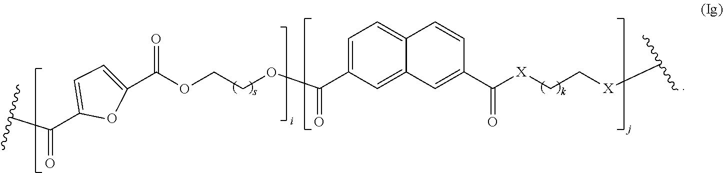

11. The polymer according to claim 2, wherein the polymer has the structure of formula (Ih):

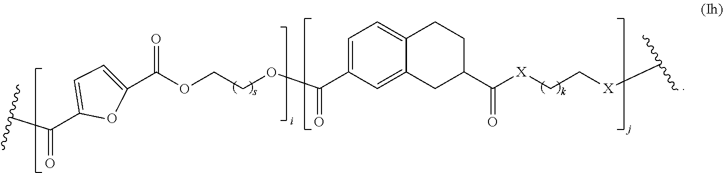

12. The polymer according to claim 2, wherein the polymer has the structure of formula (Ii):

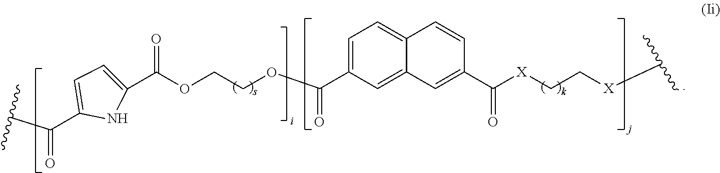

13. The polymer according to claim 2, wherein the polymer has the structure of formula (Ij):

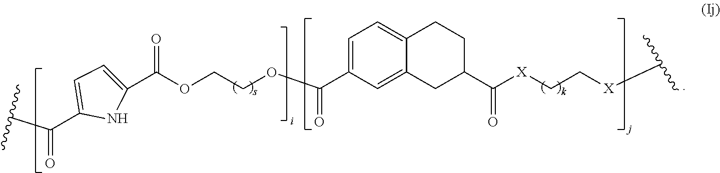

14. The polymer according to claim 2, wherein the polymer has the structure of formula (Ik):

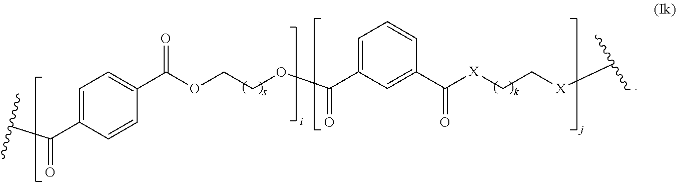

15. The polymer according to claim 2, wherein the polymer has the structure of formula (Ia′):

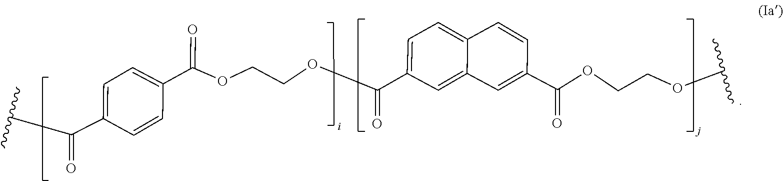

16. The polymer according to claim 2, wherein the polymer has the structure of formula (Ik′):

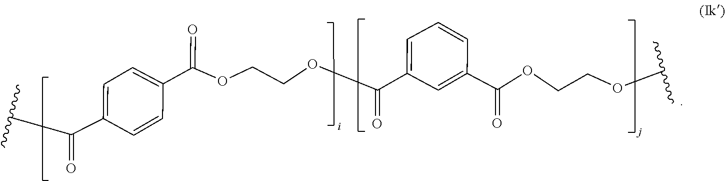

17. The polymer according to claim 1, wherein the polymer has the structure of formula

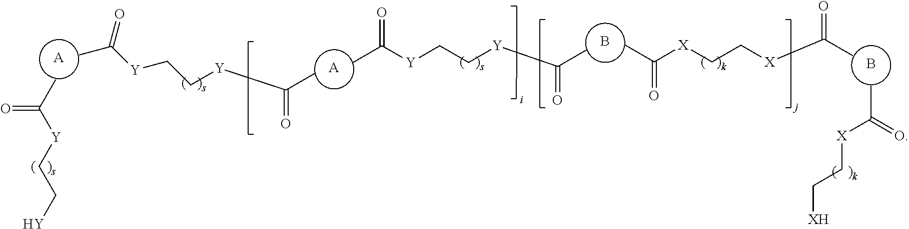

18. A process for preparation of a polymer comprising a moiety of formula: 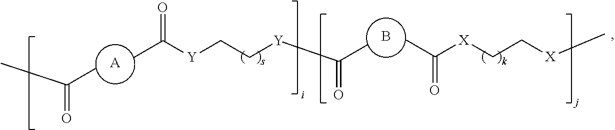
wherein 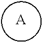
is monocyclic or bicyclic arylene, monocyclic or bicyclic heteroarylene, or monocyclic or bicyclic non-aromatic heterocyclene; 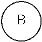
is monocyclic or bicyclic arylene, monocyclic or bicyclic heteroarylene, or monocyclic or bicyclic non-aromatic heterocyclene, wherein monocyclic or bicyclic arylene, monocyclic or bicyclic heteroarylene, or monocyclic or bicyclic non-aromatic heterocyclene can be optionally substituted from 1 to 3 times with R;
X is NH or O;
Y is NH or O;
R is independently selected at each occurrence thereof from the group consisting of H, OH, and —OR′;
R′ is C₁₋₂₀ alkyl, C₂₋₂₀ alkenyl, or C₂₋₂₀ alkynyl;
s is 1 to 21;
k is 1 to 21;
i and j represent number average degrees of polymerization for repeat units of formula I that are distributed throughout the polymer chain in a statistically defined manner;
i is 1 to 1,000,000; and
j is 1 to 1,000,000;
or a salt thereof,
said process comprising:
providing a compound having the structure of formula (IV): 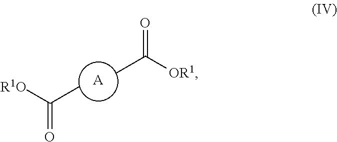
wherein R¹ is H or C₁₋₆ alkyl;
providing a compound having the structure of formula (V): 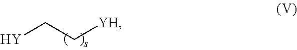
or a salt thereof,
providing a compound having the structure of formula (VI): 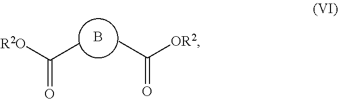
wherein R² is H or C₁₋₆ alkyl;
providing a compound having the structure of formula (VII): 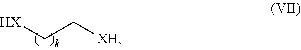
or a salt thereof, and
reacting the compound of formula (IV), the compound of formula (V), the compound of formula (VI), and the compound of formula (VII) under conditions effective to produce the polymer.

19.-25. (canceled)

26. A process for preparation of a polymer comprising a moiety of formula: 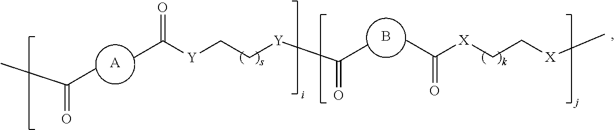
wherein 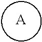
is monocyclic or bicyclic arylene, monocyclic or bicyclic heteroarylene, or monocyclic or bicyclic non-aromatic heterocyclene; 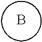
is monocyclic or bicyclic arylene, monocyclic or bicyclic heteroarylene, or monocyclic or bicyclic non-aromatic heterocyclene, wherein monocyclic or bicyclic arylene, monocyclic or bicyclic heteroarylene, or monocyclic or bicyclic non-aromatic heterocyclene can be optionally substituted from 1 to 3 times with R;
X is NH or O;
Y is NH or O;
R is independently selected at each occurrence thereof from the group consisting of H, OH, and —OR′;
R′ is C₁₋₂₀ alkyl, C₂₋₂₀ alkenyl, or C₂₋₂₀ alkynyl;
s is 1 to 21;
k is 1 to 21;
i and j represent number average degrees of polymerization for repeat units of formula I that are distributed throughout the polymer chain in a statistically defined manner;
i is 1 to 1,000,000; and
j is 1 to 1,000,000;
or a salt thereof,
said process comprising:
providing a compound having the structure of formula (II): 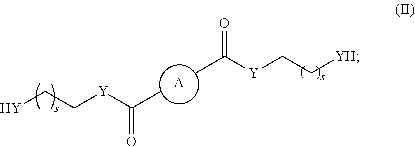
providing a compound having the structure of formula (III): 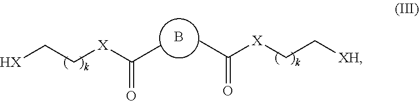
or a salt thereof, and
reacting the compound of formula (II) with the compound of formula (III) under conditions effective to produce the polymer.

27.-31. (canceled)

32. A packaging composition comprising the polymer of claim 1.

33. (canceled)
